(19) United States
(12) Patent Application Publication
(10) Pub. No.: US 2023/0381041 A1
(43) Pub. Date: Nov. 30, 2023

(54) METHODS AND DEVICES FOR REPOSITIONING A PATIENT ON A SUPPORT APPARATUS

(71) Applicant: SENECA DEVICES, INC., Durham, NC (US)

(72) Inventors: Samuel T. Fox, Durham, NC (US); Liam Anderson, Durham, NC (US); Nicholas Ponder, Raleigh, NC (US)

(21) Appl. No.: 18/326,549

(22) Filed: May 31, 2023

Related U.S. Application Data
(60) Provisional application No. 63/347,370, filed on May 31, 2022.

(51) Int. Cl. A61G 7/10; A61G 7/057; A61G 5/10

(52) U.S. Cl. CPC A61G 7/1021; A61G 7/05769; A61G 5/1091

(57) ABSTRACT

Various implementations include a device for moving a person on a support apparatus. The device includes a base, an expandable volume, a slider, and a sheet. The base has a support apparatus coupler for coupling the device to a portion of a support apparatus. The expandable volume is coupled to the base and is actuatable from a first position to a second position. A first portion of the sheet is stationary with respect to the base. The sheet extends from adjacent a first side of the expandable volume, over the expandable volume, around a portion of the slider adjacent a second side of the expandable volume, over the expandable volume, and over the first side of the expandable volume. Actuation of the expandable volume from the first position to the second position increases a length of the sheet from the second side to the first side of the expandable volume.

### BACKGROUND

Patients who are confined to a bed or wheel chair often rely on other people to assist them in moving in the bed or wheel chair. Due to gravitational forces, patients often tend to slide toward the foot end of inclined beds or toward the edge of the seat of an upright wheel chair. Because of factors like the weight of the patient, the position of the bed or the wheel chair, and the strength of the assisting person, moving the patient back toward the head end of the bed or toward the back support of the wheel chair can be a challenging task.

Often, an assisting person positions a sheet or towel under the patient such that a portion of the sheet or towel extends from underneath the patient. The assisting person then pulls the sheet or towel in the direction of the extending portion of the sheet or towel to slide the patient in the bed or wheel chair. This method of moving a person still presents challenges for the assisting person, due to the relative weight of the patient and strength of the assisting person.

Previous devices attempting to solve this problem include a long sheet connected to a roller at the head end of a bed and a roller at the foot end of the bed. The patient is positioned on the portion of the sheet extending along the top surface of the bed between the two rollers. When the patient needs to be moved toward the head end of the bed, a motor rotates the roller at the head end of the bed, rolling a portion of the sheet from the roller at the foot end of the bed toward the head end of the bed. The rolling of the sheet causes the patient positioned on the sheet to be moved toward the head end of the bed. As the patient later slides toward the foot end of the bed due to movement and gravity, more of the sheet is rolled onto the roller on the head end of the bed to move the patient back toward the head end of the bed. However, this roller mechanism presents a pinching hazard around the mattress and may require electronic components in close proximity to the patient. Furthermore, it can be difficult to comprehensively clean the roller or other components where the sheet is attached to the device.

Thus, a need exists for a device that can move a patient toward the head end of a bed that does not involve physical force from the assisting person, does not present a pinching hazard, does not place electronics in close proximity to the patient, and remains easy to comprehensively clean.

Patients who are confined to a bed must also be laterally turned on a regular basis to prevent bed sores and allow the caregiver to access the patient's back side for hygiene, skin assessment, and wound care procedures, as well as the placement of devices including transfer slings, sheets, towels, and bedpans. Because of the height or width of some patients and the narrowness of some beds, some patients laying in the supine position in the center of a bed do not have enough space to be fully turned on the patient's side in a comfortable manner that allows the caregiver access to the patient's back side. For the same reasons discussed above with respect to moving a patient toward the head end of the bed, both moving the patient laterally on the bed and turning the patient onto the patient's side can be very difficult for the assisting person.

Turning a patient in a bed becomes even more difficult when turning the patient a full 180 degrees from a supine position to a prone position, or vice versa. The limited width of a standard hospital bed does not provide enough distance to either side of an average patient laying in the center of the mattress to roll 180 degrees before contacting the side rails of the bed. This problem is exacerbated when the person in the bed is obese because the person will have less distance to either side of the person and will move a longer distance when rolling 180 degrees.

Currently, to turn a person 180 degrees in a hospital bed, multiple caregivers must perform a series of manually shifting the patient to one side of the bed, manually turning the patient toward the opposite side of the bed, and repeating these steps until the patient has turned a full 180 degrees. Other current methods of turning a patient 180 degrees in a bed include lowering a side rail of the bed, abutting another structure such as a stretcher against the lowered side rail, manually shifting the patient onto the abutting structure, and then manually rolling the patient back onto the bed. However, both of these currently used methods involve multiple caregivers providing manual movement of the patient.

Thus, a need exists for a method of turning a person 180 degrees in a bed that limits the physical force involved from the assisting person.

Another issue with hospital beds is that, no matter whether a device is used to pull patients up in bed, the patient slides down 1-2 inches over the repositioning sheet each time the patient is boosted. After roughly 5-10 repositionings (depending on the patient's weight, mobility, length of the sheet, and angle of boost), the repositioning sheet cannot be used to reposition the patient anymore because of the cumulative effect of the patient sliding on the repositioning sheet each boost. Thus, the repositioning sheet itself must be “reset” or repositioned under the patient before an additional 5-10 boosts can be performed.

With all existing solutions that pull patients up in bed, this “sheet reset” process requires multiple caregivers and physical strain. The reset process is mechanically intensive, time-consuming, and (if the patient is in the bed which is always the case in the ICU) involves musculoskeletal strain for nurses. Thus, even current devices that are “zero-strain” boosting devices still require physical strain when the sheet needs to be reset once every 5-10 boosts, which is necessary every 24-48 hours for an ICU patient.

Additionally, many of the current reset processes are different from the nurses' normal workflow. Thus, parts of these processes are not intuitive, such as needing to detach the sheet from the motor drive, unclip the edges of the sheet at multiple locations, etc. Nurses often do not have time to change their clinical workflow, which creates a major disadvantage for existing devices.

Thus, there is a need for a method of resetting the repositioning sheet of a bed as a part of nurses' normal workflow that does not cause the nurses additional physical strain.

### SUMMARY

Various implementations include a device for moving a person on a support apparatus. The device includes a base, an expandable volume, a slider, and a sheet. The base has a support apparatus coupler for coupling the device to a portion of a support apparatus. The expandable volume is coupled to the base. The expandable volume has a first side and a second side opposite and spaced apart from the first side. The expandable volume is actuatable from a first position to a second position. The slider is disposed adjacent the second side of the expandable volume. The sheet has a first portion and a second portion opposite and spaced apart from the first portion. The second portion is for supporting a patient. The first portion of the sheet is stationary with respect to the base. The sheet extends from adjacent the first side of the expandable volume, over the expandable volume, around a portion of the slider adjacent the second side of the expandable volume, over the expandable volume, and over the first side of the expandable volume. Actuation of the expandable volume from the first position to the second position increases a length of the sheet extending from the second side of the expandable volume to the first side of the expandable volume.

In some implementations, the sheet includes one or more tethers and a sheet body. In some implementations, the one or more tethers have a first tether portion and a second tether portion longitudinally spaced apart from the first tether portion. In some implementations, the first tether portion includes the first portion of the sheet and the second tether portion is coupled to the sheet body. In some implementations, the second tether portion of the one or more tethers are removably coupled to the sheet body. In some implementations, the sheet further includes a buckle for removably coupling the second tether portion of the one or more tethers to the sheet body. In some implementations, the buckle includes a side release buckle. In some implementations, the side release buckle includes a male portion and a female portion. In some implementations, the male portion is coupled to the sheet body, and the female portion is coupled to the second tether portion of the one or more tethers.

In some implementations, the sheet further includes a carabiner for removably coupling the second tether portion of the one or more tethers to the sheet body.

In some implementations, the sheet further includes a strap and ladder lock buckle for removably coupling the second tether portion of the one or more tethers to the sheet body.

In some implementations, the one or more tethers extend adjacent the first side of the expandable volume, over the expandable volume, and around a portion of the slider adjacent the second side of the expandable volume when the expandable volume is in the second position.

In some implementations, one of the first tether portion or the second tether portion is longitudinally adjustable along the one or more tethers to change a distance from the sheet body to the first tether portion.

In some implementations, the expandable volume is biased toward the first position by a spring force and urgable toward the second position. In some implementations, an elastic band causes the spring force.

In some implementations, the base includes a rigid base portion that is movable when the expandable volume actuates from the first position to the second position. In some implementations, the rigid base portion is a first base portion and the base further includes a second base portion. In some implementations, one of the first base portion or the second base portion includes the support apparatus coupler. In some implementations, the expandable volume is disposed between the first base portion and the second base portion such that the second base portion moves relative to the first base portion when the expandable volume actuates from the first position to the second position. In some implementations, the second base portion has a first end and a second end, and the first end of the second base portion is pivotably coupled to the first base portion. In some implementations, the second base portion pivots relative to the first base portion when the expandable volume actuates from the first position to the second position.

In some implementations, the base further includes a base cover. In some implementations, the first base portion and the second base portion are disposed within the base cover. In some implementations, the first end of the second base portion is pivotably coupled to the first base portion by the base cover.

In some implementations, the base portion comprises aluminum. In some implementations, the base portion defines one or more cavities.

In some implementations, the device further includes a volume cover. In some implementations, the expandable volume is disposed within the volume cover. In some implementations, the volume cover includes at least one sewn seam. In some implementations, a maximum volume of the volume cover is less than a maximum volume of the expandable volume such that the volume cover prevents the expandable volume from expanding to its maximum volume.

In some implementations, the slider includes a rigid or semi-rigid bar. In some implementations, the slider includes a rope, strap, or chain. In some implementations, the slider includes a D-ring or carabiner.

In some implementations, the slider is a first slider. In some implementations, the device further includes a second slider disposed adjacent the first side of the expandable volume. In some implementations, the sheet extends from adjacent the second side of the expandable volume, over the expandable volume, and around a portion of the second slider adjacent the first side of the expandable volume prior to extending adjacent the first side of the expandable volume, over the expandable volume, around the portion of the first slider adjacent the second side of the expandable volume, over the expandable volume, and over the first side of the expandable volume.

In some implementations, the device further includes a third slider disposed adjacent the second side of the expandable volume. In some implementations, the sheet extends from adjacent first side of the expandable volume, over the expandable volume, and around a portion of the third slider adjacent the second side of the expandable volume prior to extending adjacent the second side of the expandable volume, over the expandable volume, around the portion of the second slider adjacent the first side of the expandable volume and extending adjacent the first side of the expandable volume, over the expandable volume, around the portion of the first slider adjacent the second side of the expandable volume, over the expandable volume, and over the first side of the expandable volume.

In some implementations, the expandable volume includes an inflatable cushion. In some implementations, the device further includes a pumping device for actuating the inflatable cushion from the first position to the second position. In some implementations, the pumping device is disposed externally to the inflatable cushion.

In some implementations, the expandable volume includes a linear actuator.

In some implementations, the second portion of the sheet is closer to the base in the second position than in the first position.

In some implementations, the support apparatus is a bed, and the support apparatus coupler is couplable to or adjacent to a head end of a mattress of the bed. In some implementations, the support apparatus is a bed, and the support apparatus coupler is couplable to or adjacent to a side end of a mattress of the bed. In some implementations, the support apparatus is a bed, and the support apparatus coupler is couplable to or adjacent to a foot end of a mattress of the bed. In some implementations, the support apparatus is a bed, and the support apparatus coupler is couplable to or adjacent to a head end of a frame of the bed. In some implementations, the support apparatus is a bed, and the support apparatus coupler is couplable to or adjacent to a side end of a frame of the bed. In some implementations, the support apparatus is a bed, and the support apparatus coupler is couplable to or adjacent to a foot end of a frame of the bed.

In some implementations, the support apparatus coupler is couplable adjacent a bottom side of a mattress of the bed. In some implementations, actuation of the expandable volume from the first position to the second position raises a portion of the mattress of the bed.

In some implementations, the device further includes a strain gauge for measuring the strain exerted on the sheet.

In some implementations, the device further includes an air supply tubing configured to supply air to the expandable volume to cause the expandable volume to move from the first position to the second position. In some implementations, the air supply tubing extends from adjacent the base, along the second side of the expandable volume, and to an expandable volume inlet port disposed between the first side and second side and with which the air supply tubing is in fluid communication. In some implementations, the air supply tubing includes two or more air supply tubings each extending from adjacent the base, along the second side of the expandable volume, and to an expandable volume inlet port disposed between the first side and second side and with which each of the two or more air supply tubings are in fluid communication.

Various other implementations include a device for moving a person on a support apparatus. The device includes a base, an expandable volume, and a slider. The base has a support apparatus coupler for coupling the device to a portion of a support apparatus. The expandable volume is coupled to the base. The expandable volume has a first side and a second side opposite and spaced apart from the first side. The slider is disposed adjacent the second side of the expandable volume. The expandable volume is actuatable from a first position to a second position. Actuation of the expandable volume from the first position to the second position increases a length as measured from the second side of the expandable volume, over the expandable volume, to the first side of the expandable volume.

In some implementations, the base includes a sheet coupler for affixing a sheet to the base. In some implementations, the sheet coupler includes one or more tethers. In some implementations, the one or more tethers have a first tether portion and a second tether portion longitudinally spaced apart from the first tether portion. In some implementations, the first tether portion is stationary with respect to the base and the second tether portion is couplable to the sheet. In some implementations, the second tether portion of the one or more tethers are removably coupled to the sheet. In some implementations, the one or more tethers further includes a buckle for removably coupling the second tether portion of the one or more tethers to the sheet. In some implementations, the buckle includes a side release buckle. In some implementations, the side release buckle includes a male portion and a female portion. In some implementations, the male portion is coupled to the sheet and the female portion is coupled to the second tether portion of the one or more tethers.

In some implementations, the one or more tethers further include a carabiner for removably coupling the second tether portion of the one or more tethers to the sheet.

In some implementations, the one or more tethers further include a strap and ladder lock buckle for removably coupling the second tether portion of the one or more tethers to the sheet.

In some implementations, the one or more tethers are extendable adjacent the first side of the expandable volume, over the expandable volume, and around a portion of the slider adjacent the second side of the expandable volume when the expandable volume is in the second position.

In some implementations, one of the first tether portion or the second tether portion is longitudinally adjustable along the one or more tethers to change a distance from the sheet body to the first tether portion.

In some implementations, the expandable volume is biased toward the first position by a spring force and urgable toward the second position. In some implementations, an elastic band causes the spring force.

In some implementations, the base includes a rigid base portion that is movable when the expandable volume actuates from the first position to the second position. In some implementations, the rigid base portion is a first base portion and the base further includes a second base portion. In some implementations, one of the first base portion or the second base portion includes the support apparatus coupler. In some implementations, the expandable volume is disposed between the first base portion and the second base portion such that the second base portion moves relative to the first base portion when the expandable volume actuates from the first position to the second position. In some implementations, the second base portion has a first end and a second end, and the first end of the second base portion is pivotably coupled to the first base portion. In some implementations, the second base portion pivots relative to the first base portion when the expandable volume actuates from the first position to the second position.

In some implementations, the base further includes a base cover. In some implementations, the first base portion and the second base portion are disposed within the base cover. In some implementations, first end of the second base portion is pivotably coupled to the first base portion by the base cover.

In some implementations, the base portion comprises aluminum. In some implementations, the base portion defines one or more cavities.

In some implementations, the device further includes a volume cover. In some implementations, the expandable volume is disposed within the volume cover. In some implementations, the volume cover includes at least one sewn seam. In some implementations, a maximum volume of the volume cover is less than a maximum volume of the expandable volume such that the volume cover prevents the expandable volume from expanding to its maximum volume.

In some implementations, the slider includes a rigid or semi-rigid bar. In some implementations, the slider includes a rope, strap, or chain. In some implementations, the slider includes a D-ring or carabiner.

In some implementations, the slider is a first slider. In some implementations, the device further includes a second slider disposed adjacent the first side of the expandable volume.

In some implementations, the device further includes a third slider disposed adjacent the second side of the expandable volume.

In some implementations, the expandable volume includes an inflatable cushion. In some implementations, the device further includes a pumping device for actuating the inflatable cushion from the first position to the second position. In some implementations, the pumping device is disposed externally to the inflatable cushion.

In some implementations, the expandable volume includes a linear actuator.

In some implementations, the support apparatus is a bed, and the support apparatus coupler is couplable to or adjacent to a head end of a mattress of the bed. In some implementations, the support apparatus is a bed, and the support apparatus coupler is couplable to or adjacent to a side end of a mattress of the bed. In some implementations, the support apparatus is a bed, and the support apparatus coupler is couplable to or adjacent to a foot end of a mattress of the bed. In some implementations, the support apparatus is a bed, and the support apparatus coupler is couplable to or adjacent to a head end of a frame of the bed. In some implementations, the support apparatus is a bed, and the support apparatus coupler is couplable to or adjacent to a side end of a frame of the bed. In some implementations, the support apparatus is a bed, and the support apparatus coupler is couplable to or adjacent to a foot end of a frame of the bed.

In some implementations, the support apparatus coupler is couplable adjacent a bottom side of a mattress of the bed. In some implementations, actuation of the expandable volume from the first position to the second position raises a portion of the mattress of the bed.

In some implementations, the device further includes a strain gauge for measuring the strain exerted on a sheet affixed to the base.

In some implementations, the device further including an air supply tubing configured to supply air to the expandable volume to cause the expandable volume to move from the first position to the second position. In some implementations, the air supply tubing extends from adjacent the base, along the second side of the expandable volume, and to an expandable volume inlet port disposed between the first side and second side and with which the air supply tubing is in fluid communication. In some implementations, the air supply tubing includes two or more air supply tubings each extending from adjacent the base, along the second side of the expandable volume, and to an expandable volume inlet port disposed between the first side and second side and with which each of the two or more air supply tubings are in fluid communication.

Various other implementations include a method of replacing a sheet on a support apparatus while supporting a person. The method includes providing a support apparatus having a first side, a second side opposite the first side, a center portion located between the first side and the second side of the support apparatus, and a top surface extending between the first side and the second side, the support apparatus including a first sheet disposed along at least a portion of the top surface, the first sheet having a first side and a second side, wherein a person is disposed on the first sheet; elevating the first side of the support apparatus to cause the person to move in a direction toward the second side of the support apparatus; moving the first side of the sheet in a direction toward the second side of the support apparatus such that the first side of the sheet is gathered at the center portion of the support apparatus; elevating the second side of the support apparatus to cause the person to move in a direction toward the first side of the support apparatus; removing the first sheet from the support apparatus; disposing a second sheet on the top surface of the support apparatus such that the second side of the second sheet is disposed adjacent the second side of the support apparatus and the first side of the second sheet is gathered at the center portion of the support apparatus; elevating the first side of the support apparatus to cause the person to move in a direction toward the second side of the support apparatus; and moving the first side of the sheet in a direction toward the first side of the support apparatus such that the first side of the sheet is disposed adjacent the first side of the support apparatus.

In some implementations, the support apparatus further has a bottom surface opposite the top surface. In some implementations, the support apparatus further includes a first expandable volume device disposed adjacent the bottom surface and first side of the support apparatus and a second expandable volume device disposed adjacent the bottom surface and second side of the support apparatus. In some implementations, elevating the first side of the support apparatus is caused by the first expandable volume device. In some implementations, elevating the second side of the support apparatus is caused by the second expandable volume device.

In some implementations, the first sheet is coupled to at least a portion of the support apparatus prior to elevating the first side of the support apparatus. In some implementations, the method further includes uncoupling the first sheet from the portion of the support apparatus prior to elevating the first side of the support apparatus. In some implementations, the method further includes coupling the second sheet to at least a portion of the support apparatus after removing the first sheet from the support apparatus.

In some implementations, the method further includes disposing a second sheet on the top surface of the support apparatus includes disposing the second sheet closer to a foot of the support apparatus than the first sheet when the first sheet was removed.

In some implementations, the first sheet is a sling. In some implementations, the second sheet is a sling.

Various other implementations include a device for overlaying an inflatable cushion. The device includes a body having a first side and a second side opposite the first side. The second side is configured to be disposed on a surface of the inflatable cushion. The device has a first axis extending along the second side and a second axis extending perpendicular to the first axis and along the second side. The body is rigid in a direction along the first axis. The body is flexible in a direction along the second axis such that the body can be curved in a direction perpendicular to the first axis and the second axis.

In some implementations, the method further includes an inflatable cushion. In some implementations, the second side is disposed on a surface of the inflatable cushion.

In some implementations, the device includes a plurality of rigid rods. In some implementations, each of the rods extends parallel to the first axis. In some implementations, the plurality of rods includes fiberglass. In some implementations, the plurality of rods includes metal. In some implementations, the plurality of rods includes a polymer. In some implementations, the plurality of rods includes a composite. In some implementations, one or more of the rods are hollow.

In some implementations, the rods have a length in the range of 6 inches to 36 inches. In some implementations, the length of the rods is 20 inches. In some implementations, the rods have a diameter in the range of 0.125 inches to 0.375 inches. In some implementations, one or more of the rods has a circular cross section. In some implementations, each of the rods is spaced apart from an immediately adjacent rod by distance in the range of 0.5 inches to 1 inch.

In some implementations, the plurality of rods includes at least three rods. In some implementations, each of the rods is spaced apart from an immediately adjacent rod by an equal distance.

In some implementations, the body further includes a plurality of sleeves. In some implementations, each of the rods is disposed within a different one of the sleeves. In some implementations, the body includes two sheets coupled together to form at least one of the sleeves.

In some implementations, the inflatable cushion includes one or more web assemblies configured to be disposed on the first side of the body. In some implementations, the one or more web assemblies includes two web assemblies and the two web assemblies are spaced a distance from each other. In some implementations, the distance is in the range of 14 inches to 50 inches.

In some implementations, the body is curved in a direction perpendicular to the first axis and the second axis into a roll having a diameter of 10 inches or less.

### BRIEF DESCRIPTION OF DRAWINGS

Example features and implementations are disclosed in the accompanying drawings. However, the present disclosure is not limited to the precise arrangements and instrumentalities shown.

FIGS. 1A and 1B are side views of a device for moving a person on a bed toward the head end of the bed, according to one implementation.

FIGS. 2A-2C are plan views of the device of FIGS. 1A and 1B coupled to different portions of the frame of a bed and the mattress of a bed.

FIGS. 3A and 3B are side views of a device for moving a person in a wheel chair toward the top of the back support of the wheel chair, according to another implementation.

FIG. 4 is a perspective view of a device for moving a person on a bed toward the head end of the bed, according to another implementation.

FIGS. 5A and 5B are side views of a device for moving a person on a bed, according to another implementation.

FIGS. 6A and 6B are end views of a device for moving and turning a person on a bed, according to the implementation of FIG. 5.

FIGS. 7A and 7B are side views of a device for moving a person on a bed, according to another implementation.

FIGS. 8A and 8B are side views of a device for moving a person on a bed, according to another implementation.

FIG. 9A is a perspective view of a sheet for being coupled to the device for moving a person on a bed shown in FIGS. 6A and 6B, according to one implementation.

FIG. 9B and 9C are detail views of the first elastic strip of the sheet of FIG. 9A.

FIG. 10 is a perspective view of a sheet for being coupled to the device for moving a person on a bed shown in FIGS. 6A and 6B, according to another implementation.

FIGS. 11A and 11B are end views of a device for moving and turning a person on a bed, according to the implementation of FIGS. 6A and 6B, and including the device for moving a person on a bed shown in FIG. 4 and the sheet shown in FIGS. 9A-9C.

FIGS. 12A and 12B are end views of a device for moving and turning a person on a bed, according to another implementation.

FIGS. 13A-13F are end views of the steps of a method of turning a person in a range of 90-180 degrees on a support apparatus, according to one implementation.

FIG. 14A shows a side view of a device for moving a person on a bed toward the head end of the bed in the first position, according to another implementation.

FIG. 14B shows a side view of the device for moving a person on a bed toward the head end of the bed of FIG. 14A in the second position.

FIG. 15 shows a side view of a device for moving a person on a bed toward the head end of the bed, according to another implementation.

FIG. 16 shows a side view of a device for moving a person on a bed toward the head end of the bed, according to another implementation.

### DETAILED DESCRIPTION

The devices disclosed herein allow a person to be easily moved and/or turned in a bed, chair, or other support apparatus. The devices include an expandable volume such as an inflatable cushion, rotatable arm, or actuator. A sheet is coupled to the device and extends over the expandable volume onto the bed, chair, or other support apparatus such that a person can lay or sit on a portion of the sheet. When the expandable volume is actuated, the expandable volume increases the distance which the sheet extends over it, which pulls the portion of the sheet supporting the person toward the device.

Various implementations include a device for moving a person on a support apparatus with a sheet. The device includes a base, an expandable volume, and a sheet. The base has a first side and a second side opposite and spaced apart from the first side. The base has a support apparatus coupler for coupling the device to a portion of a support apparatus. The expandable volume is disposed on a surface of the base between the first side and the second side. The expandable volume is actuatable from a first position to a second position. The sheet has a first portion and a second portion opposite and spaced apart from the first portion. The second portion is for supporting a patient. The first portion of the sheet is stationary with respect to the base. The sheet extends from the first portion, over the second side, over the expandable volume, and over the first side. Actuation of the expandable volume from the first position to the second position increases a length of the sheet extending from the second side of the base to the first side of the base. Moving the sheet moves the person on the support apparatus.

Various other implementations include a device for moving a person on a support apparatus. The device includes a base and an expandable volume. The base has a first side and a second side opposite and spaced apart from the first side. The base has a support apparatus coupler for coupling the device to a portion of a support apparatus. The expandable volume is disposed on a surface of the base between the first side and the second side. The expandable volume is actuatable from a first position to a second position. Actuation of the expandable volume from the first position to the second position increases a length as measured from the second side, over the expandable volume, to the first side.

Various other implementations include a sheet for use with a device for moving a person on a support apparatus. The sheet includes a main body and a first elastic portion. The main body has a first sheet edge and a second sheet edge spaced apart and opposite from the first sheet edge. The first elastic strip has a first edge and a second edge spaced apart and opposite the first edge. The first elastic strip is resiliently biased toward a relaxed position and urgable to an extended position. The first elastic strip further has a first relaxed width as measured between the first and second edges of the first elastic strip in the relaxed position. The first edge of the first elastic strip is coupled to the first sheet edge and the second edge of the first elastic strip is coupled to a first portion of the main body. A distance between the first sheet edge and the first portion of the main body is greater than the first relaxed width.

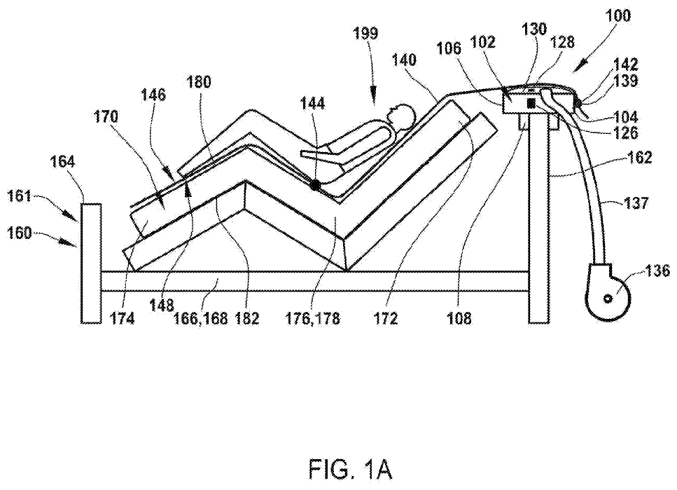

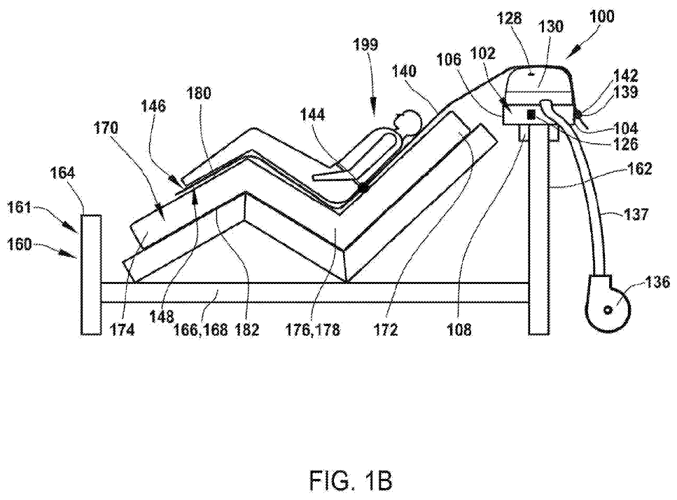

FIGS. 1A and 1B show a device 100 for moving a person 199 on a support apparatus 160. The support apparatus 160 shown in FIGS. 1A and 1B is a bed 160 having bed frame 161 and a mattress 170. However, in other implementations, the support apparatus can be gurney, a stretcher, an operating table, a chair, a wheelchair, or any apparatus on which a person is supported and is prone to move into a less preferred position and would need adjustment. The bed frame 161 has a head end 162, a foot end 164 opposite and spaced apart from the head end 162, and side ends 166, 168. The mattress 170 has a head end 172 for being disposed adjacent the head end 162 of the bed frame 161 and a foot end 174 opposite and spaced apart from the head end 172 of the mattress 170. The mattress 170 also has two side ends 176, 178 each extending from the head end 172 of the mattress 170 to the foot end 174 of the mattress 170. The mattress 170 further has a top surface 180 and a bottom surface 182 opposite and spaced apart from the top surface 180.

The device 100 shown in FIGS. 1A and 1B includes a base 102, an expandable volume 130, and a sheet 140. The base 102 has a first side 104 and a second side 106 opposite and spaced apart from the first side 104. The base 102 shown in FIGS. 1A and 1B is manufactured from a rigid material, but in other implementations, the base is manufactured from a flexible material, such as a woven material or any thin material. In some implementations, the base is a strap.

The support apparatus coupler 108 is disposed on the first side 104 of the base 102. The support apparatus coupler 108 couples the device 100 to a portion of the support apparatus 160 such that the device 100 is anchored to the support apparatus 160 and does not move relative to support apparatus 160 when the device 100 is used. The support apparatus coupler 108 shown in FIGS. 1A and 1B includes a pair of clamps for coupling the device 100 to the head end 162 of the bed frame 161, as discussed below. However, in other implementations, the support apparatus coupler includes a sleeve that securely fits over the head end 162 of the bed frame 161, one or more straps that fit around the head end 162 of the bed frame 161, one or more ratcheting straps that fit around the head end 162 of the bed frame 161, one or more hook and loop strips, fasteners, a sewn stitch connecting to the head end 162 of the bed frame 161, a friction coating, an adhesive, or any other coupler capable of keeping the device coupled to the support apparatus when overcoming the forces applied to the device when the device is moving a person on the support apparatus, as discuss in more detail below.

The support apparatus coupler 108 of the device 100 in FIGS. 1A and 1B is coupled to the head end 162 of the bed frame 161. However, in other implementations, the support apparatus coupler is coupled to the foot end of the bed frame, a side end of the bed frame, the head end of the mattress, the foot end of the mattress, a side end of the mattress, or any other portion of either the bed frame or mattress in which direction the sheet is desired to be pulled, as discussed below. In some implementations, the support apparatus coupler is coupled to the bottom surface of a mattress. In some implementations, the device is not coupled to a portion of the support apparatus. In some implementations, the device is integrated into a portion of the support apparatus, such as the bed frame, the mattress, or the wheelchair. In some implementations, the device is disposed between the bottom surface of the mattress and a portion of the bed frame. As mentioned above, in some implementations, the support apparatus can be gurney, a stretcher, an operating table, a chair, a wheelchair, or any apparatus on which a person is supported and is prone to move into a less preferred position and would need adjustment.

The expandable volume 130 acts as a cam to increase the distance as measured from the second side 106 of the base 102, over the expandable volume 130, to the first side 104 of the base 102 when the expandable volume 130 is actuated from a first position to a second position. When the expandable volume 130 is actuated from a first position to a second position, the expandable volume 130 increases the volume of the of space between the sheet 140 and the base 102 such that the distance as measured from the second side 106 of the base 102, over the expandable volume 130, to the first side 104 of the base 102 increases. Thus, the expandable volume 130 acts as a cam to create a longer distance for the sheet 140 to travel around the base 102. The expandable volume 130 shown in FIGS. 1A and 1B is disposed on the outwardly facing surface of the base 102 of the device 100 between the first side 104 of the base 102 and the second side 106 of the base 102. The expandable volume 130 can be coupled to the base 102 of the device 100 in any way capable of holding the expandable volume 130 stationary relative to the base 102, such as one or more stitches, buttons, a zipper, adhesive, or fasteners. The expandable volume 130 shown in the illustrated implementations of FIGS. 1A and 1B as an inflatable cushion. The expandable volume 130 is actuatable between a first position (shown in FIG. 1A), wherein the inflatable cushion is in a deflated state, and a second position (shown in FIG. 1B), wherein the cushion is fully inflated. However, in other implementations, the first position and the second position are any other states of expansion possible with the expandable volume. The expandable volume 130 shown in FIGS. 1A and 1B is disposed on the outwardly facing surface of the base 102, but in other implementations, the expandable volume is disposed on the inwardly facing surface of the base.

The device 100 can also include an electric pumping device 136 for actuating the inflatable cushion from the first position to the second position. The pumping device 136 in FIGS. 1A and 1B is an electric air compressor disposed externally to the inflatable cushion. The pumping device 136 is located external to the expandable volume 130 to limit noise and vibrations from disturbing the person 199 disposed on the support apparatus 160. However, in other implementations, the pumping device is disposed on the base, is disposed on or within the support apparatus 160, or is disposed on or within the expandable volume. In some implementations, the pump is a manual pump.

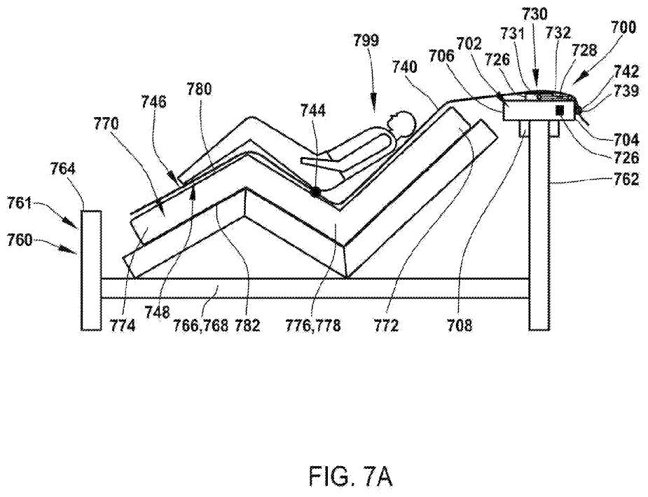

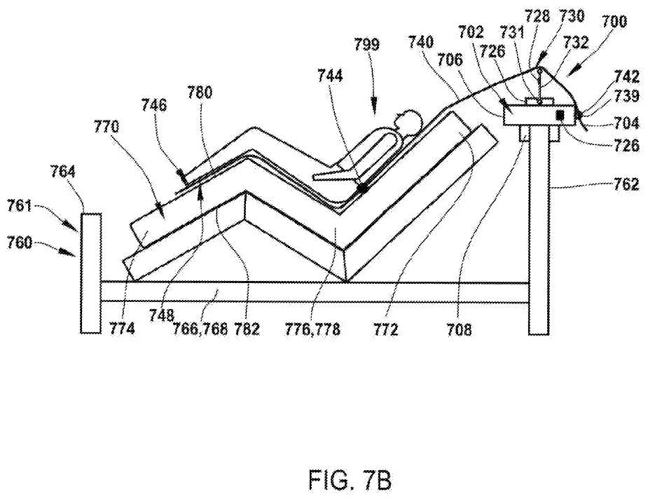

FIGS. 7A and 7B show an implementation of the device 700 including an expandable volume 730 that is a rotatable arm. The rotatable arm includes a shaft 731 and an arm 732. The device also includes a motor 726 coupled to the shaft 731 for rotating the rotatable arm from a first position wherein the arm 732 is perpendicular to the second side 706 (shown in FIG. 7A) to a second position wherein the arm 732 is parallel to the second side 706 (shown in FIG. 7B). When the expandable volume 730 is actuated from the first position to the second position, the distance as measured from the second side 706 of the base 702, over the expandable volume 730, to the first side 704 of the base 702 is increased. Thus, the second portion 744 of the sheet 740 is moved closer to the base 702 when the expandable volume 730 is actuated from the first position to the second position. Although FIGS. 7A and 7B show an electric motor 726 for actuating the expandable volume 730, in some implementations, the shaft of the rotatable arm includes a handle for actuating the expandable device from a first position to a second position.

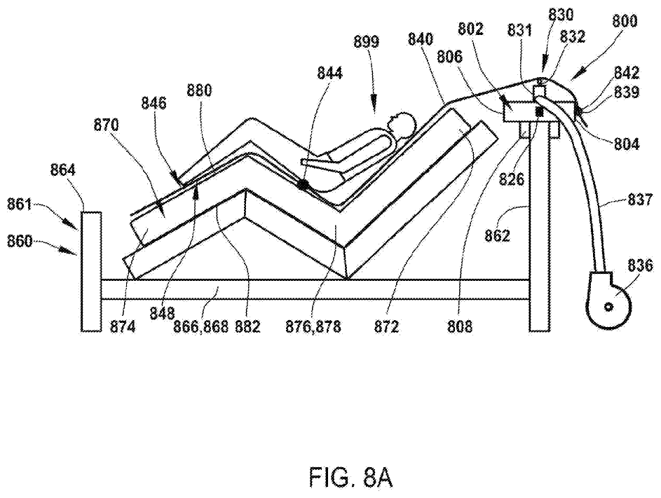

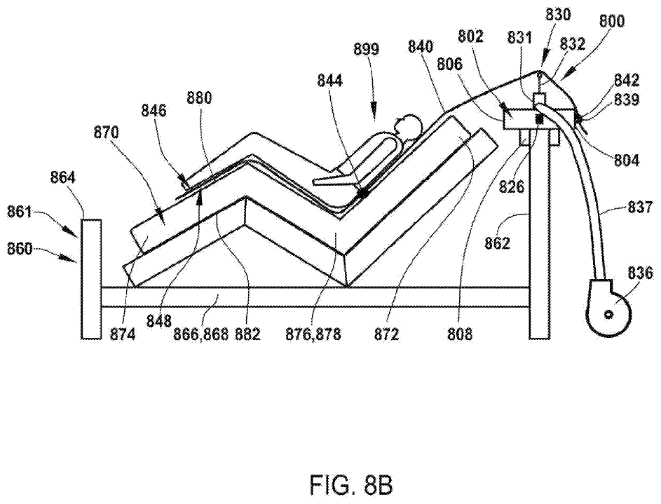

FIGS. 8A and 8B show an implementation of the device 800 including an expandable volume 830 that is a telescoping arm. The telescoping arm includes a cylinder body 831 and a piston rod 832. The device also includes a pump 836 coupled to the cylinder body 831 for introducing air into the cylinder body 831 to cause the piston rod 832 to actuate from a first position wherein the piston rod 832 is retracted toward the base 802 (shown in FIG. 8A) to a second position wherein the piston rod 832 is extended away from the base 802 (shown in FIG. 8B). When the expandable volume 830 is actuated from the first position to the second position, the distance as measured from the second side 806 of the base 802, over the expandable volume 830, to the first side 804 of the base 802 is increased. Thus, the second portion 844 of the sheet 840 is moved closer to the base 802 when the expandable volume 830 is actuated from the first position to the second position. In some implementations, the pump is a manual pump.

The device 100 shown in FIGS. 1A and 1B also includes a sheet 140. The sheet 140 has a first portion 142 and a second portion 144 opposite and spaced apart from the first portion 142. The first portion 142 of the sheet 140 is removably coupled to the base 102 such that the sheet 140 can be removed from the device 100 for cleaning or disposal. The first portion 142 of the sheet 140 remains stationary with respect to the base 102 of the device 100 even with movement of the person 199. The sheet 140 extends from the first portion 142 where it is coupled, over the second side 106 of the base 102, over the expandable volume 130, and over the first side 104 of the base 102. The sheet 140 continues to extend over the top surface 180 of the mattress 170 such that the second portion 144 of the sheet 140 is under and supporting the person 199. The sheet 140 is decouplable from the base 102 so that it can be disposable. For example, the first portion 142 of the sheet 140 is coupled to the base 102 by clamps. However, in other implementations, the first portion of the sheet is coupled to the base by one or multiple fasteners, including hook and loop, a zipper, an adhesive, or any other coupler capable of keeping the sheet coupled to the device when overcoming the forces applied to the sheet when the sheet is moving a person on the support apparatus, as discuss in more detail below. In some implementations, the first portion of the sheet is coupled to a portion of the support apparatus such that the first portion of the sheet remains stationary with respect to the device. In some implementations, the sheet is permanently coupled to the device or support apparatus.

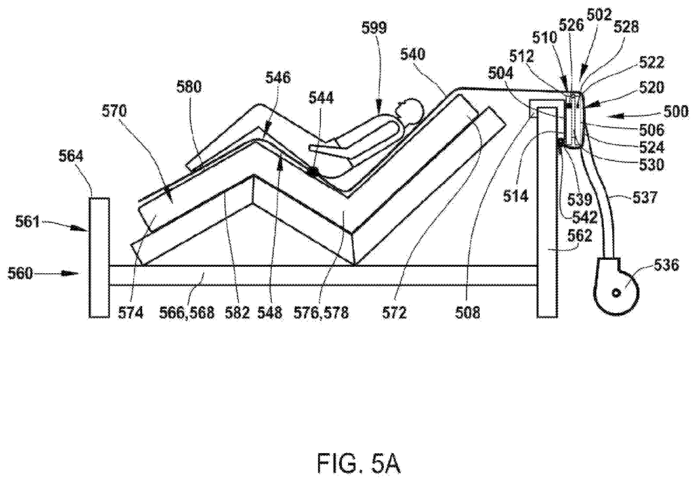

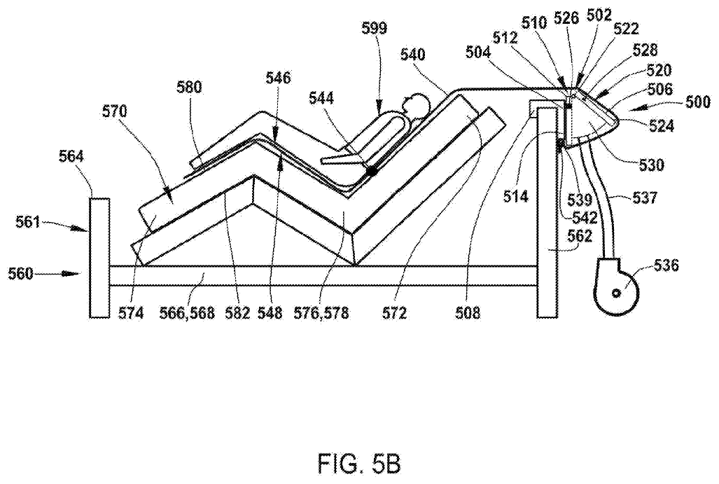

The device 100 also includes a sensor 126 coupled to the base 102 for determining the position of the expandable volume 130. The sensor 126 shown in FIGS. 1A and 1B is an ultrasonic distance sensor, and a tab 128 extends from the expandable volume 130 such that the sensor 126 can measure the distance between the sensor 126 and the tab 128. In other implementations, the sensor can be any other distance sensor, such as, an infrared sensor, an inductive sensor, a capacitive sensor, a photoelectric sensor, or any other sensor capable of measuring the distance of displacement of a portion of the expandable volume when the expandable volume is actuated from the first position to the second position, or vice versa. In other implementations, the sensor is an angular sensor, such as a rotary encoder, and the sensor is coupled to a rotating shaft (such as shaft 731 shown in FIGS. 7A and 7B) or a hinge (as shown in FIGS. 5A and 5B). In other implementations, the sensor is a pressure sensor disposed at least partially within an inflatable cushion or linear actuator type expandable volume.

In use, the expandable volume 130 begins in the first position. When the person 199 needs to be moved on the support apparatus 160 in the direction of the device 100, the pumping device 136 is powered to introduce pressurized air through a conduit 137 into the expandable volume 130. As the expandable volume 130 inflates, the expandable volume 130 moves to the second position. As the expandable volume 130 is actuated from the first position to the second position, the length of the sheet 140 extending from the second side 106 of the base 102 to the first side 104 of the base 102 is increased such that the second portion 144 of the sheet 140 is moved closer to the base 102 of the device 100 in the second position than in the first position. In other words, a length as measured from the second side 106 of the base 102, over the expandable volume 130, to the first side 104 of the base 102 is increased as the device is actuated from the first position to the second position. Because the second portion 144 of the sheet 140 is moved closer to the base 102 of the device 100 when the expandable volume 130 is actuated from the first position to the second position, the person 199 supported by the second portion 144 of the sheet 140 is also moved toward the device 100 such that the person 199 is boosted toward the head end 162 of the bed frame 161 and the head end 172 of the mattress 170.

Once the person 199 is moved to the desired position in the support apparatus 160, the expandable volume 130 is actuated from the second position back to the first position. For the device 100 shown in FIGS. 1A and 1B, the actuation of the expandable volume 130 from the second position to the first position includes releasing the pressure in the inflatable cushion such that the pressurized air within the inflatable cushion can flow out of the inflatable cushion. However, in other implementations, the pumping device is reversable, and the pumping device 136 can be actuated in reverse to suction the air from the inflatable cushion. If the patient's hips are approximately aligned with the hinge of the mattress and with sufficient friction between the person 199, the sheet 140, and the mattress 170, the person 199 will not immediately slide back away from the device 100 when the expandable volume 130 is actuated from the second position back to the first position. Although the sheet 140 of the device 100 shown in FIGS. 1A and 1B extends from the second side 106 of the base 102, over the expandable volume 130, to the first side 104 of the base 102, in some implementations, the sheet only extends from the second side of the base and over the expandable volume but does not extend to the first side of the base before extending toward and under the person. In these implementations, actuation of the expandable volume from the first position to the second position increases the length of the sheet as measured from the second side of the base to a point on the expandable volume where the sheet no longer contacts the expandable volume.

The device 100 includes a strain gauge 139 between the first portion 142 of the sheet 140 and the portion of the base 102 to which the first portion 142 of the sheet 140 is coupled. In some implementations, the strain gauge 139 is integrated into a portion of the sheet 140. When the person 199 is moved to the desired position in the support apparatus 160 and the expandable volume 130 is actuated from the second position back to the first position, it is desired that gravity causes the person 199 to slide back down the mattress 170 until the posterior of the person 199 is disposed on the mattress 170 such that the person 199 is prevented from further movement on the mattress 170. In this position, if the knee section of the bed 160 is properly elevated, the person's 199 hips are approximately in line with the hinge of the bed 160 on the mattress 170, which facilitates redistribution of pressure across the patient's body on the mattress 170. Because the patient is in the desired position, rather than out of the desired position such that the person 199 is supported by the friction of the sheet 140, the person 199 will not immediately further move or slide on the mattress 170 when the sheet 140 is moved toward the device 100. However, in some circumstances, gravity may not cause the person 199 to slide on the mattress to this desired position when the expandable volume 130 is actuated from the second position back to the first position, and the friction between the sheet 140 and the person 199 may prevent the person 199 from moving to the desired resting position. Over time, the force exerted on the back of the person 199 by the friction of the sheet 140 as the sheet 140 holds the person 199 can cause pressure sores. The pressure gauge 139 is configured to measure the strain being put on the sheet 140. The device 100 is configured to alert an assisting person when the strain measured by the strain gauge 139 is higher than a predetermined amount, indicating that the friction of the sheet 140 is holding an undesirable amount of the weight of the person 199. Thus, the strain a person 199 in the desired position puts on the sheet 140 is lower than the predetermined amount of strain.

In some implementations, the strain gauge 139 is configured to measure the strain on the sheet 140, and when the strain on the sheet 140 exceeds the predetermined amount of strain, the strain gauge 139 sends a signal to cause the expandable volume 130 to move from the first position to the second position to boost the person 199 in the support apparatus 160. When the expandable volume 130 moves from the second position to the first position such that the person 199 is in the desired position, as discussed above, the strain gauge 139 will measure a strain on the sheet 140 less than the predetermined amount. Over time, the person 199 may slide on the support apparatus 160, putting additional strain on the sheet 140. When the person 199 has moved far enough on the support apparatus 160 such that the strain on the sheet 140 exceeds the predetermined amount, the strain gauge 139 will send a signal, causing the expandable volume 130 to move from the first position to the second position to boost the person 199.

The sheet 140 shown in FIGS. 1A and 1B has a first side 146 for contacting the person 199 and a second side 148 opposite the first side 146 for contacting the mattress 170. The first side 146 of the sheet 140 is manufactured such that the relationship between the first side 146 of the sheet 140 and the skin of a person 199 has a first coefficient of friction, and the second side 148 of the sheet 140 is manufactured such that the relationship between the second side 148 of the sheet 140 and the mattress 170 has a second coefficient of friction. As discussed above, once the person 199 has been moved on the support apparatus 160, the expandable volume 130 is actuated from the second position back to the first position, which releases the tension in the sheet 140 between the device 100 and the person 199. The friction between the person 199 and the sheet 140, and the sheet 140 and the mattress 170, can prevent the person 199 from initially sliding back to the person's 199 prior position (i.e., away from the device 100). In some implementations, a second sheet (such as a fitted sheet) can be disposed between the sheet and the mattress to provide a consistent friction between the sheet and the bed.

As the person 199 moves in the support apparatus 160 over time, the person 199 may begin to slide on the support apparatus 160 away from the device 100. For repeated use of the device 100 for moving a person 199, low movement of the person 199 relative to the sheet 140 is desired such that subsequent actuation of the expandable volume 130 from the first position to the second position moves the person 199 back to the same position on the support apparatus 160 without the need for repositioning the sheet 140 under the person 199. Thus, for the sheet shown in FIGS. 1A and 1B, the first coefficient of friction between the first side 146 of the sheet 140 and the skin of the person 199 is higher than the second coefficient of the friction between the second side 148 of the sheet 140 and the mattress 170 such that the sheet 140 will slide along the mattress 170, rather than the person 199 sliding along the sheet 140. The sheet 140 shown in FIGS. 1A and 1B has a first coefficient of friction of 0.46 and a second coefficient of friction of 0.33. However, in other implementations, the first coefficient of friction can be any value greater than the second coefficient of friction. In some implementations, the second coefficient of friction is between 0.20 and 0.50. In some implementations, the second coefficient of friction is between 0.30 and 0.35.

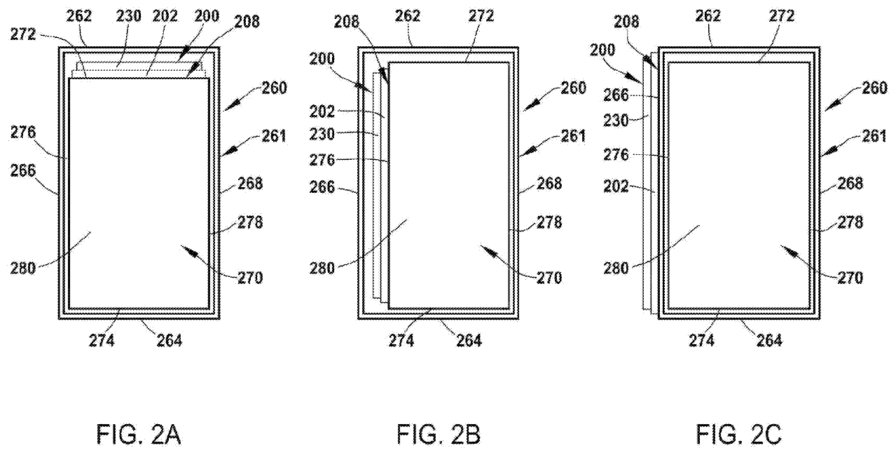

FIGS. 2A-2C show top views of various ways in which the support apparatus coupler 208 of the device 200 can be coupled to different portions of a bed 260. FIG. 2A shows the support apparatus coupler 208 coupled to the head end 272 of the mattress 270 of the bed 260. FIG. 2B shows the support apparatus coupler 208 coupled to the side end 276 of the mattress 270 of the bed 260. FIG. 2C shows the support apparatus coupler 208 coupled to the side end 266 of the frame of the bed 260.

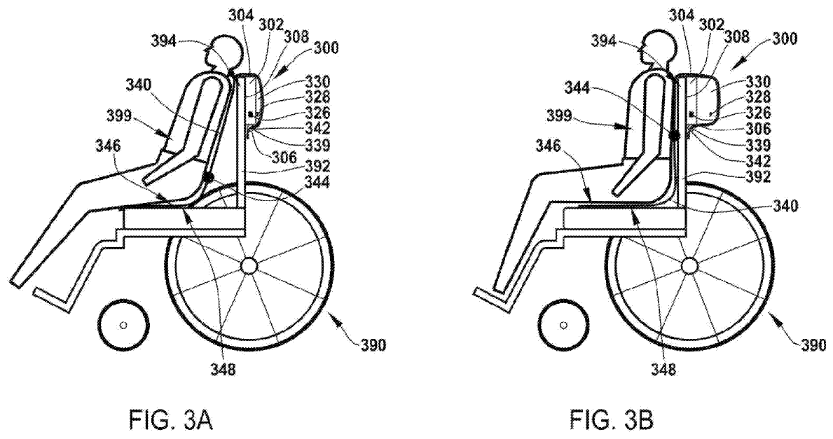

FIGS. 3A and 3B show a device 300 similar to the device 100 shown in FIG. 1, but the support apparatus 390 to which the device 300 in FIGS. 3A and 3B is coupled is a wheel chair 390. The support apparatus coupler 308 shown in FIGS. 3A and 3B is coupled to the back support 392 of the wheel chair 390 such that the sheet 340 extends over a top end 394 of the back support 392 and the second portion 344 of the sheet 340 supports the posterior of the person 399. In use, actuation of the expandable volume 330 from the first position (shown in FIG. 3A) to the second position (shown in FIG. 3B) causes the second portion 344 of the sheet 340 to move toward the device 300, causing the posterior of the person 399 to move toward the back support 392 and the back of the person 399 toward the top end 394 of the back support 392 of the wheel chair 390.

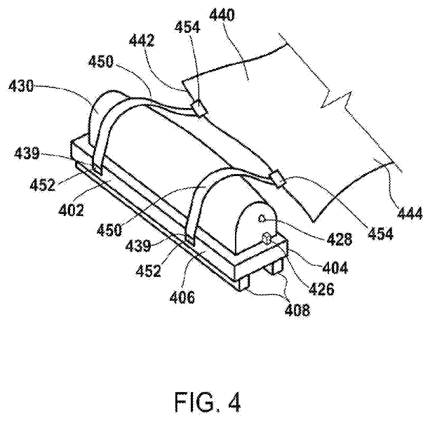

FIG. 4 shows a device 400 similar to the device 100 shown in FIG. 1, but a sheet 440 is not directly coupled to the base 402 of the device 400 shown in FIG. 4. Instead, the base 402 of the device 400 includes a sheet coupler 450 for coupling the sheet 440 to the device 400. The sheet coupler 450 includes a web assembly having a first web assembly portion 452 coupled to the base 402 and a second web assembly portion 454 for affixing a sheet 440 to the base 402. The web assembly in FIG. 4 includes two straps that extend over the second side 406 of the base 402, over the expandable volume 430, and over the first side 404 of the base 402. The second web assembly portion 454 is coupled to a first portion 442 of a sheet 440, and the second portion 444 of the sheet 440 is supporting a person 499 (not shown). The web assembly functions as an extension of the sheet 440, allowing the device 400 to use a standard size sheet 440 and operate in the same way as described above with respect to the device 100 shown in FIG. 1. In some implementations, the second web assembly portion is coupled to a garment worn by the person, and actuation of the expandable volume moves the garment and person toward the device.

FIGS. 5A and 5B show another implementation of a device 500. The device 500 shown in FIGS. 5A and 5B is similar to the devices 200, 300, 400 shown in FIGS. 1-4, but the base 502 of the device 500 shown in FIGS. 5A and 5B includes a first base portion 510 rotatably coupled to a second base portion 520 with an expandable volume 530 disposed between the first base portion 510 and a second base portion 520. The first base portion 510 of the device 500 has a first end 512 and a second end 514 and includes the support apparatus coupler 508. The second base portion 520 also has a first end 522 and a second end 524. The first end 522 of the second base portion 520 is pivotably coupled to the first end 512 of the first base portion 510. The expandable volume 530 is disposed between the first base portion 510 and the second base portion 520 such that the second base portion 520 pivots relative to the first base portion 510 when the expandable volume 530 actuates from the first position to the second position. The first base portion 510 and the second base portion 520 of the device 500 shown in FIGS. 5A and 5B are pivotably coupled by a hinge, but in other implementations, the first base portion and the second base portion are pivotably coupled by any linkage capable of allowing the first and second base portions to pivot relative to each other while withstanding the forces exerted on the base during operation.

The first base portion 510 of the device 500 includes the first side 504, and the second base portion 520 includes the second side 506. The sheet 540 included in the device 500 in FIGS. 5A and 5B extends over the second side 506 of the second base portion 520, over the expandable volume 530, and over the first side 504 of the first base portion 510. Although the sheet 540 extends over the expandable volume 530 in this implementation, the sheet 540 in FIG. does not contact the expandable volume 530 in either the first position or the second position. However, in some implementations, the sheet does contact the expandable volume in the first position, the second position, or both. The inclusion of the first base portion and the second base portion allow the expandable volume disposed between the first base portion and the second base portion to expand more evenly, and thus more predictably, than in the other implementations of the device shown in FIGS. 1-4. This configuration also allows the device 500 to be mounted in different locations on, and at different angles relative to, the support apparatus 560.

When the expandable volume 530 is actuated from the first position (shown in FIG. 5A) to the second position (shown in FIG. 5B), the expandable volume 530 causes the second base portion 520 to pivot relative to the first base portion 510 at the first end 522 of the second base portion 520, increasing the length of the portion of sheet 540 as measured from the second side 506, over the expandable volume 530, to the first side 504. Because of the increase in length of this portion of sheet 540, the second portion 544 of the sheet 540, and the person 599 supported by the second portion 544 of the sheet 540, are moved closer to the device 500.

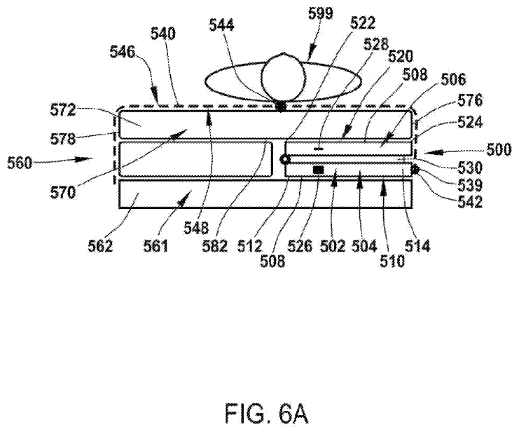

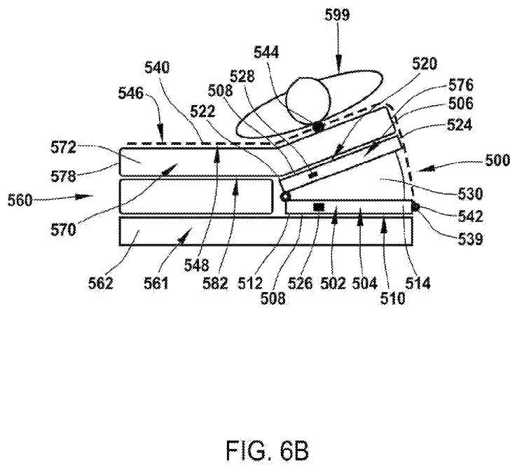

FIGS. 6A and 6B show the same device 500 shown in FIGS. 5A and 5B, but in FIGS. 6A and 6B, the device 500 is disposed at the side end 576 of a mattress 570 of a bed 560 to allow a person 599 to be easily turned on the person's side. As seen in FIG. 6A, some people 599 are too wide, and the bed 560 too narrow, to be fully turned directly on the person's 599 side in a comfortable manner. Thus, to have enough space to turn the person 599 on the person's 599 side, a person 599 must be moved toward one of the side ends 576, 578 of the mattress 570 before or concurrently with being turned in the direction of the opposite side end 576, 578 of the mattress 570.

The device 500 shown in FIGS. 6A and 6B is disposed adjacent the bottom surface 582 of the mattress 570 between the mattress 570 and the bed frame such that the second base portion 520 of the device 500 is in contact with the bottom surface 582 of the mattress 570. The support apparatus coupler 508 of the device 500 shown in FIGS. 6A and 6B is a friction coating disposed on the outer surfaces of the first base portion 510 and the second base portion 520. The friction between the bottom surface 582 of the mattress 570 and the device 500 and the friction between the bed frame 561 and the device 500 are sufficient to couple the device 500 to the bed 560. However, in other implementations, the support apparatus coupler includes a sleeve that securely fits over the side end of the bed frame, one or more straps that fit around the side end of the bed frame, one or more ratcheting straps that fit around the side end of the bed frame, one or more hook and loop strips, fasteners, a sewn stitch connecting to the side end of the bed frame, a friction coating, an adhesive, or any other coupler capable of keeping the device coupled to the support apparatus when overcoming the forces applied to the device when the device is moving a person on the support apparatus. In some implementations, the support apparatus coupler is coupled to or integral with the mattress of the bed. As described with respect to FIGS. 5A and 5B, when the expandable volume 530 of the device 500 is actuated from the first position (shown in FIG. 6A) to the second position (shown in FIG. 6B), the device 500 moves the second portion 544 of the sheet 540 toward the side end 576 of the mattress 570 where the device 500 is located. However, because the device 500 is disposed on the bottom surface 582 of the mattress 570, actuation of the expandable volume 530 from the first position to the second position raises the side end 576 portion of the mattress 570 disposed directly above the device 500. Thus, as the device 500 causes the side end 576 of the mattress 570 to rise with respect to the bed frame, creating an incline in the mattress 570, the second portion 544 of the sheet 540 moves up the incline in the mattress 570 toward the side end 576 of the mattress 570 where the device 500 is disposed. Because the second portion 544 of the sheet 540 is supporting the person 599, the person 599 is moved up the inclined side end 576 of the mattress 570. Once the person 599 is moved toward the side end 576 of the mattress 570, enough space exists to turn the person 599 toward the other side end 578 of the mattress 570. Because the person 599 has been moved onto the inclined portion of the mattress 570, the person 599 can easily be turned onto the person's 599 side.

Although FIGS. 6A and 6B show a device 500 having a first base portion 510 and a second base portion 520 hingedly coupled around the expandable volume 530, in other implementations, the expandable volume has only a single base like the expandable volume 130 of device 100 shown in FIGS. 1A and 1B. Such a device can be disposed adjacent the bottom surface of the mattress between the mattress and the bed frame such that the expandable volume of the device is in contact with the bottom surface of the mattress.

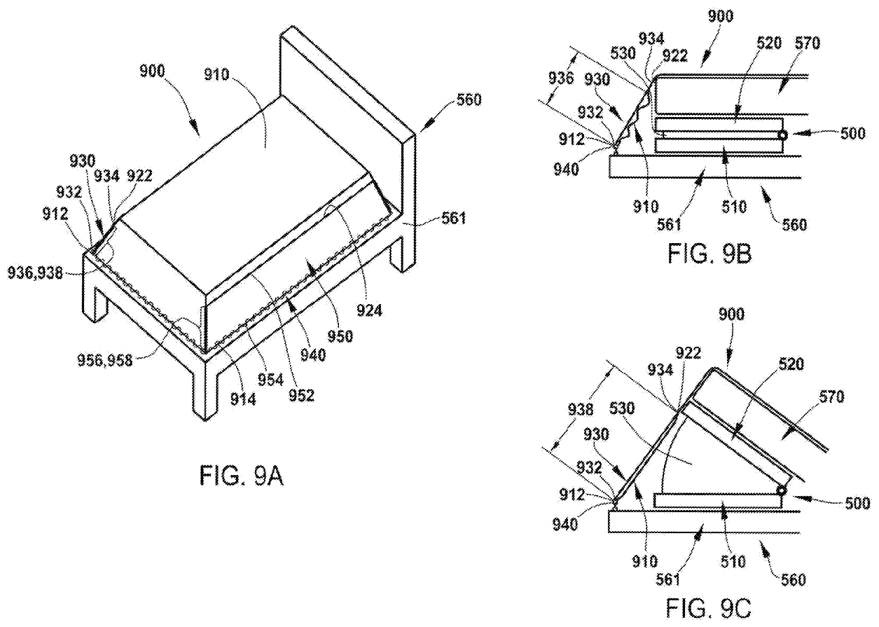

FIGS. 9A-9C shows a sheet 900 for use with the device 500 for moving a person on a support apparatus shown in FIGS. 6A and 6B. The sheet 900 has a main body 910, a first elastic strip 930, and a second elastic strip 950. The elastic strips 930, 950 are disposed along the sides of the sheet 900 and allow for the sheet 900 to expand when the device 500 is actuated from the first position to the second position. When the device 500 is actuated from the second position back to the first position, the resilient elastic strips 930, 950 retract the main body 910 of the sheet 900 back to the relaxed position, shifting the sheet 900 back to its original position rather than allowing the sheet 900 to stay shifted to one side of the bed 560.

The main body 910 of the sheet 900 has a first sheet edge 912 and a second sheet edge 914 spaced apart and opposite from the first sheet edge 912. The first sheet edge 912 and the second sheet edge 914 are configured to be disposed adjacent the side ends 576, 578 of the bed 560.

The main body 910 of the sheet 900 includes a coupler 940, shown in FIG. 9A as a half of a zipper, extending along the edge 912, 914 of the main body 910. The coupler 940 of the main body 910 is configured such that the main body 910 of the sheet 900 can be coupled to another half of a zipper affixed to the frame 561 of the bed 560. Although the coupler 940 shown in FIG. 9A is a zipper, in other implementations, the coupler is by one or multiple fasteners, including hook and loop, an adhesive, a button/loop, straps, or any other coupling device capable of keeping the main body of the first sheet edge and second sheet edge stationary relative to the bed frame. In some implementations, only the first sheet edge and the second sheet edge include couplers. Although the coupler 940 in FIG. 9A-9C is shown coupled to a portion of the frame 561 of the bed 560, in other implementations, the coupler is coupled to at least a portion of the device, the mattress, the support apparatus, or any other object such that the edges of the main body are stationary with respect to the first and second elastic strips.

The first elastic strip 930 has a first edge 932 and a second edge 934 spaced apart and opposite the first edge 932, and the second elastic strip 950 has a first edge 952 and a second edge 954 spaced apart and opposite the first edge 952. The first and second elastic strips 930, 950 are made from spandex, but in other implementations, the first and second elastic strips are made of any elastic fabric. The first and second elastic strips 930, 950 are resiliently biased toward a relaxed position and urgable to an extended position. The first edge 932 of the first elastic strip 930 is coupled to the first sheet edge 912, and the second edge 934 of the first elastic strip 930 is coupled to a first portion 922 of the main body 910. Similarly, the second edge 954 of the second elastic strip 950 is coupled to the second sheet edge 914, and the first edge 952 of the second elastic strip 950 is coupled to a second portion 924 of the main body 910.

When the first elastic strip 930 is in the relaxed position (as shown in FIG. 9B), the first relaxed width 936, as measured between the first edge 932 and second edge 934 of the first elastic strip 930, is less than the distance between the first sheet edge 912 and the first portion 922 of the main body 910. When the first elastic strip 930 is in the extended position (as shown in FIG. 9C), the first extended width 938, as measured between the first edge 932 and second edge 934 of the first elastic strip 930, is equal to the distance between the first sheet edge 912 and the first portion 922 of the main body 910 such that the main body 910 of the sheet 900 prevents the first elastic strip 930 from being urged beyond the first extended position. Similarly, when the second elastic strip 950 is in the relaxed position, the second relaxed width 956, as measured between the first edge 952 and second edge 954 of the second elastic strip 950, is less than the distance between the second sheet edge 914 and the second portion 924 of the main body 910. When the second elastic strip 950 is in the extended position, the second extended width 958, as measured between the first edge 952 and second edge 954 of the second elastic strip 950, is equal to the distance between the second sheet edge 914 and the second portion 924 of the main body 910 such that the main body 910 of the sheet 900 prevents the second elastic strip 950 from being urged beyond the second extended position.

In FIGS. 9B and 9C, the distance between the first sheet edge 912 and the first portion 922 of the main body 910 is double the first relaxed width 936 of the first elastic strip 930, and the distance between the second sheet edge 914 and the second portion 924 of the main body 910 is double the second relaxed width 956 of the second elastic strip 950. However, in other implementations, the relative widths of the first relaxed width versus the distance between the first sheet edge and the first portion of the main body, and the relative widths of the second relaxed width versus the distance between the second sheet edge and the second portion of the main body, can be any desired ratio such that the sheet can extend when the device moves from the first position to the second position.

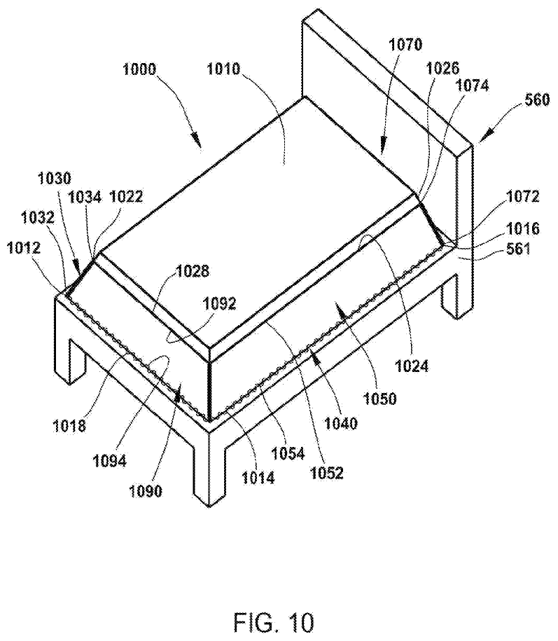

FIG. 10 shows a sheet 1000 including a first elastic strip 1030 and second elastic strip 1050 similar to the first elastic strip 930 and second elastic strip 950 of sheet 900 shown in FIGS. 9A-9C. However, the sheet 1000 shown in FIG. 10 further includes a third elastic strip 1070 and a fourth elastic strip 1090. Because the sheet 1000 includes features similar to the sheet 900 shown in FIGS. 9A-9C, features of sheet 1000 are indicated using similar reference numbers.

The third elastic strip 1070 has a first edge 1072 and a second edge 1074 spaced apart and opposite the first edge 1072, and the fourth elastic strip 1090 has a first edge 1092 and a second edge 1094 spaced apart and opposite the first edge 1092. The third and fourth elastic strips 1070, 1090 are made from spandex, but in other implementations, the third and fourth elastic strips are made of any elastic fabric. The third and fourth elastic strips 1070, 1090 are resiliently biased toward a relaxed position and urgable to an extended position. The first edge 1072 of the third elastic strip 1070 is coupled to the third sheet edge 1016, and the second edge 1074 of the third elastic strip 1070 is coupled to a third portion 1026 of the main body 1010. Similarly, the second edge 1094 of the fourth elastic strip 1090 is coupled to the fourth sheet edge 1018, and the first edge 1092 of the fourth elastic strip 1090 is coupled to a fourth portion 1028 of the main body 1010.

When the first or second elastic strip 1030, 1050 is urged to the extended position, the third and fourth elastic strips 1070, 1090 are able to extend to allow the main body 1010 of the sheet 1000 to shift toward a side of the bed 560 without the third sheet edge 1016 or the fourth sheet edge 1018 wrinkling.

For both the sheet 900 shown in FIGS. 9A-9C and for the sheet 1000 shown in FIG. 10, a fitted sheet can be disposed over the sheet 900, 1000 to act as a protective layer between the person and the sheet 900, 1000. The fitted sheet can include a drawstring around the perimeter to secure the fitted sheet onto the mattress 570 and/or bed 560 when the devices disclosed herein are actuated to move the mattress 570 and/or the sheet 900, 1000. However, a standard fitted sheet having elastic around the perimeter could be used as well.

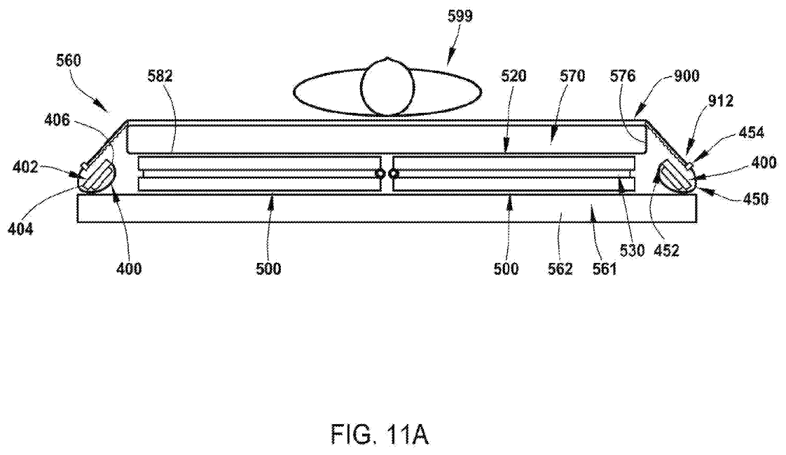

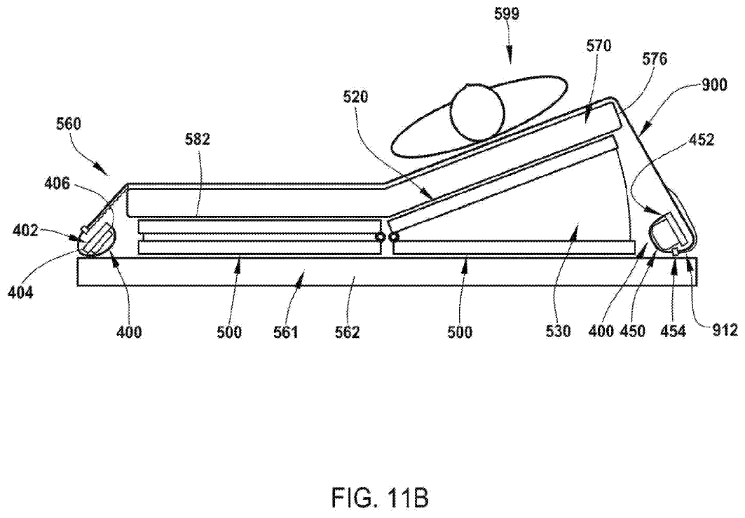

FIGS. 11A and 11B show two of the devices 500 as shown in FIGS. 6A and 6B being used with the sheet 900 shown in FIGS. 9A and 9C and two of the devices 400 shown in FIG. 4. One of the devices 500 is disposed adjacent the bottom surface 582 of the side end 576 of the mattress 570 between the mattress 570 and the bed frame 561 such that the second base portion 520 of the device 500 is in contact with the bottom surface 582 of the mattress 570. The other of the devices 500 is disposed adjacent the bottom surface 582 of the side end 578 of the mattress 570 between the mattress 570 and the bed frame 561 such that the second base portion 520 of the device 500 is in contact with the bottom surface 582 of the mattress 570. However, the first and second sheet edges 912, 914 of sheet 900 are not coupled to the devices 500 as shown in FIGS. 6A and 6B or to the bed frame 561 as shown in FIGS. 9A-9C. In FIGS. 11A and 11B, the first and second sheet edges 912, 914 of sheet 900 are coupled to the two devices 400 via sheet couplers 450.

As shown in detail in FIG. 4, the sheet couplers 450 each include a web assembly having a first web assembly portion 452 coupled to the base 402 and a second web assembly portion 454 for affixing the sheet 900 to the base 402. The web assembly in FIGS. 11A and 11B includes multiple straps that extend over the second side 406 of the base 402, over the expandable volume 430, and over the first side 404 of the base 402. The second web assembly portion 454 is coupled to first sheet edge 912 of sheet 900.

Because the sheet 900 includes the first and second elastic strips 930, 950, the sheet 900 is urged to the expanded position, as shown in FIGS. 9B and 9C, when one of the devices 500 is actuated from the first position to the second position, as shown in FIGS. 11A and 11B. Normally, rather than pulling the sheet 900 as the device is actuated, the sheet 900 is allowed to stretch and the main body 910 remains stationary relative to the mattress 570. However, the device 400 coupled adjacent the side end 576 of the mattress 570 is coupled to the first sheet edge 912 of the sheet 900 such that, when actuated from the first position to the second position contemporaneously with the actuation of device 500, device 400 pulls the first sheet edge 912 to remove any slack created by the first elastic strip 930 of the sheet 900. However, the second elastic strip 950 is still able to expand to create slack at the opposite edge of the sheet 900 such that the main body 910 of the sheet 900 can slide the person 599 in the bed 560.

Although FIGS. 11A and 11B include devices 500 for lifting portions of the mattress 570, other implementations include any other devices for moving a person on a support apparatus disclosed herein to lift portions of the mattress. Although FIGS. 11A and 11B include devices 400 for pulling the sheet 900, other implementations include any other devices for moving a person on a support apparatus disclosed herein to pull the sheet. In some implementations, rather than using the device 400 to pull the sheet 900, a roller rotatably coupled to a motor can be included for winding the sheet around the roller to pulling the sheet. Although FIGS. 11A and 11B include the sheet 900, other implementations can include the sheet 1000 disclosed in FIG. 10.

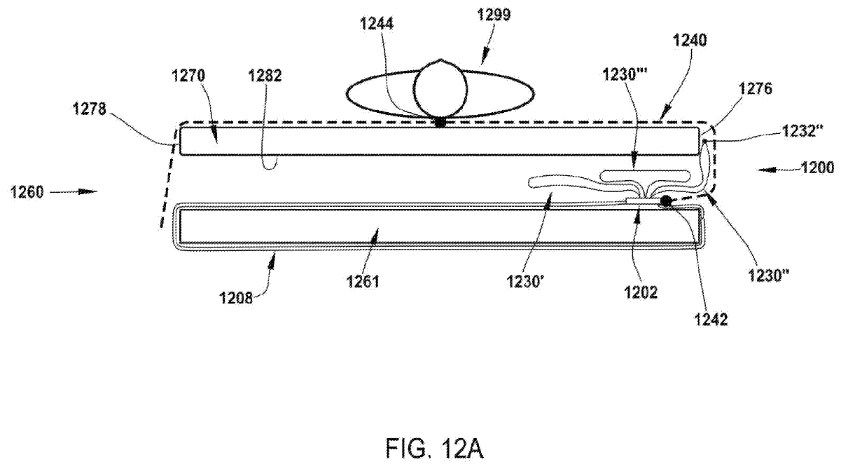

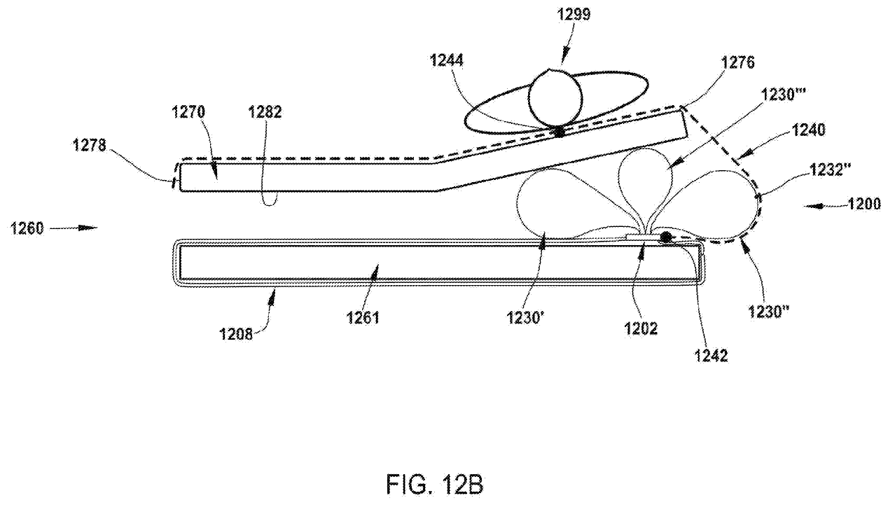

FIGS. 12A and 12B show an implementation of a device 1200 for disposing at the side end 1276 of a mattress 1270 of a bed 1260 to allow a person 1299 to be easily turned on the person's side. As seen in FIG. 12A, some people 1299 are too wide, and the bed 1260 too narrow, to be fully turned directly on the person's 1299 side in a comfortable manner. Thus, to have enough space to turn the person 1299 on the person's 1299 side, a person 1299 must be moved toward one of the side ends 1276, 1278 of the mattress 1270 before or concurrently with being turned in the direction of the opposite side end 1276, 1278 of the mattress 1270.

The device 1200 includes a base 1202 and three expandable volumes 1230. The base 1202 shown in FIGS. 12A and 12B is a strap manufactured from a flexible woven material, but in other implementations, the base is manufactured from any other flexible material, such as a thin material, or a rigid material. A first portion 1242 of a sheet 1240 is coupled to the base 1202 and a second portion 1244 of the sheet 1240 is wrapped over the side end 1276 of the mattress 1270 and over a top of the mattress 1270.

The support apparatus coupler 1208 is coupled to the base 1202. The support apparatus coupler 1208 couples the device 1200 to a portion of the bed 1260 such that the device 1200 is anchored to the bed 1260 and does not move relative to bed 1260 when the device 1200 is used. The support apparatus coupler 1208 shown in FIGS. 12A and 12B includes a strap for coupling the device 1200 around the bed frame 1261, as discussed below. However, in other implementations, the support apparatus coupler includes a sleeve that securely fits over the head end of the bed frame, one or more clamps, one or more ratcheting straps that fit around the head end of the bed frame, one or more hook and loop strips, fasteners, a sewn stitch connecting to the head end of the bed frame, a friction coating, an adhesive, or any other coupler capable of keeping the device coupled to the support apparatus when overcoming the forces applied to the device when the device is moving a person on the support apparatus and lifting a portion of the mattress, as discuss in more detail below.

The device 1200 includes an inner expandable volume 1230′, an outer expandable volume 1230″, and a middle expandable volume 1230′″.

The inner expandable volume 1230′ is disposed between the bottom surface 1282 of the mattress 1270 between the mattress 1270 and the bed frame 1261 such that the inner expandable volume 1230′ of the device 1200 is in contact with the bottom surface 1282 of the mattress 1270. When the inner expandable volume 1230′ of the device 1200 is actuated from the first position (shown in FIG. 12A) to the second position (shown in FIG. 12B), the inner expandable volume 1230′ of the device 1200 moves the second portion 1244 of the sheet 1240 toward the side end 1276 of the mattress 1270 where the device 1200 is located. However, because the device 1200 is disposed on the bottom surface 1282 of the mattress 1270, actuation of the inner expandable volume 1230′ from the first position to the second position raises the side end 1276 portion of the mattress 1270 disposed directly above the device 1200. Thus, as the inner expandable volume 1230′ of the device 1200 causes the side end 1276 of the mattress 1270 to rise with respect to the bed frame 1261, creating an incline in the mattress 1270, the second portion 1244 of the sheet 1240 moves up the incline in the mattress 1270 toward the side end 1276 of the mattress 1270 where the device 1200 is disposed. Because the second portion 1244 of the sheet 1240 is supporting the person 1299, the person 1299 is moved up the inclined side end 1276 of the mattress 1270.

The outer expandable volume 1230″ acts as a cam to increase the distance as measured from the base 1202, over the outer expandable volume 1230″, to a portion 1232″ of the outer expandable volume 1230″ when the outer expandable volume 1230″ is actuated from a first position (shown in FIG. 12A) to a second position (shown in FIG. 12B). When the outer expandable volume 1230″ is actuated from a first position to a second position, the outer expandable volume 1230″ increases the volume of the of space between the sheet 1240 and the base 1202 such that the distance as measured from the base 1202, over the outer expandable volume 1230″, to the portion 1232″ of the outer expandable volume 1230″ increases. Thus, the outer expandable volume 1230″ acts as a cam to create a longer distance for the sheet 1240 to travel around the outer expandable volume 1230″. The outer expandable volume 1230″ can be coupled to the base 1202 of the device 1200 in any way capable of holding the outer expandable volume 1230″ stationary relative to the base 1202, such as one or more stitches, buttons, a zipper, adhesive, or fasteners. The outer expandable volume 1230″ shown in the illustrated implementations of FIGS. 12A and 12B as an inflatable cushion. The outer expandable volume 1230″ is actuatable between a first position (shown in FIG. 12A), wherein the inflatable cushion is in a deflated state, and a second position (shown in FIG. 12B), wherein the cushion is fully inflated. However, in other implementations, the first position and the second position are any other states of expansion possible with the outer expandable volume. As the outer expandable volume 1230″ actuates from the first position to the second position, the device 1200 moves the second portion 1244 of the sheet 1240 further toward the side end 1276 of the mattress 1270 where the device 1200 is located as the inner expandable volume 1230′ lifts the side end 1276 of the mattress 1270.

The middle expandable volume 1230′″ is coupled to the base 1202 between, and disposed between, the inner expandable volume 1230′ and the outer expandable volume 1230″. When the middle expandable volume 1230′″ of the device 1200 is actuated from the first position (shown in FIG. 12A) to the second position (shown in FIG. 12B), the middle expandable volume 1230′″ applies pressure to the inner expandable volume 1230′ and the outer expandable volume 1230″ to force them into the desired positions. Because the middle expandable volume 1230′″ is disposed under the mattress 1270, the middle expandable volume 1230′″ also helps further raise the side end 1276 portion of the mattress 1270 disposed directly above the device 1200.

Although the inner expandable volume 1230′, outer expandable volume 1230″, and middle expandable volume 1230′″ shown in FIGS. 12A and 12B are show being actuated from the first position to the second position at the same time, in some implementations, the inner expandable volume, outer expandable volume, and middle expandable volume are inflated at different times to stage their individual functions as desired. Although the inner expandable volume 1230′, outer expandable volume 1230″, and middle expandable volume 1230′″ shown in FIGS. 12A and 12B are each inflatable devices, in other implementations, the inner expandable volume, outer expandable volume, and middle expandable volume are any other type of expandable volume disclosed herein.

Once the person 1299 is moved toward the side end 1276 of the mattress 1270, enough space exists to turn the person 1299 toward the other side end 1278 of the mattress 1270. Because the person 1299 has been moved onto the inclined portion of the mattress 1270, the person 1299 can easily be turned onto the person's 1299 side. After the device 1200 has been actuated once, the device 1200 can be deactivated to return the sheet 1240 and mattress 1270 to their original positions. The device 1200 can be actuated a plurality of times to continue to further turn the person 1299.

Although FIGS. 12A and 12B show only one device 1200 disposed under the side end 1276 of the mattress 1270, in some implementations, a second device 1200 is included under the other side end 1278 of the mattress 1270 such that the person can easily turned in the other direction.

Various other implementations include a method of turning a person in a range of 90-180 degrees on a support apparatus. The method includes providing a support apparatus having a first side, a second side opposite the first side, and a top surface extending between the first side and the second side. The support apparatus includes a first sheet disposed along at least a portion of the top surface, and a second sheet disposed along at least a portion of the first sheet such that the first sheet is disposed between the top surface and the second sheet. The first sheet has a first side and a second side. A person is disposed on the second sheet. The method further includes shifting the first sheet, relative to the support apparatus, in a direction toward the first side of the support apparatus; elevating the first side of the first sheet; shifting the second sheet, relative to the support apparatus and the first sheet, in a direction toward the second side of the support apparatus; lowering the first side of the first sheet; shifting the first sheet and the second sheet, relative to the support apparatus, in the direction toward the second side of the support apparatus; elevating the second side of the first sheet; and rolling the person in a range of 90-180 degrees in the direction toward the first side of the support apparatus.

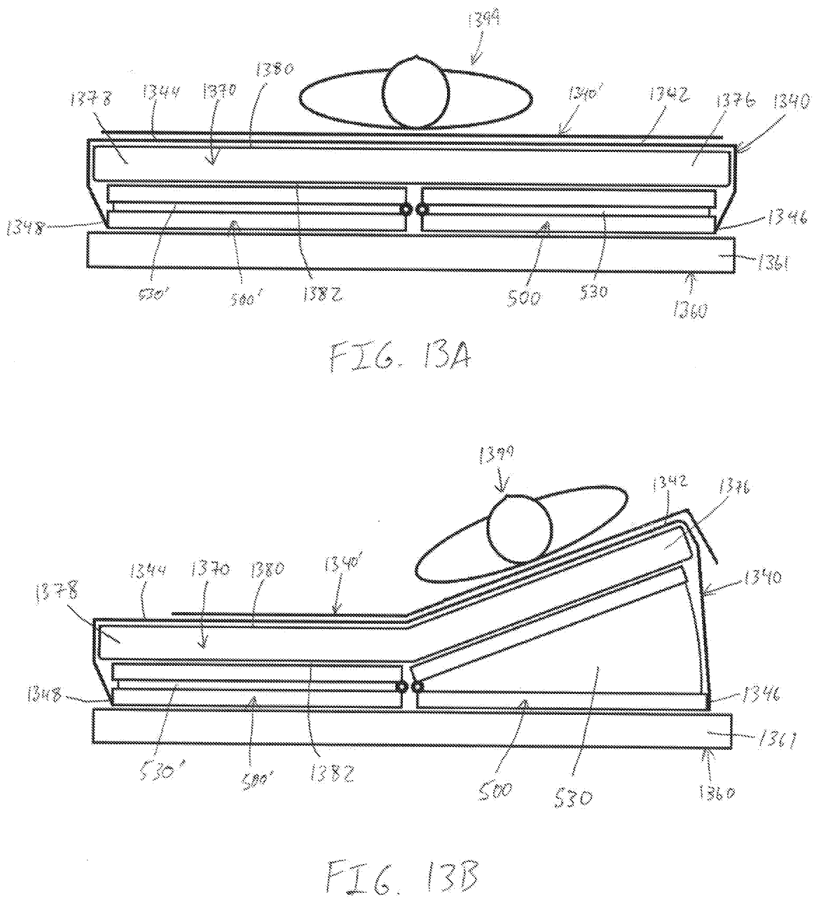

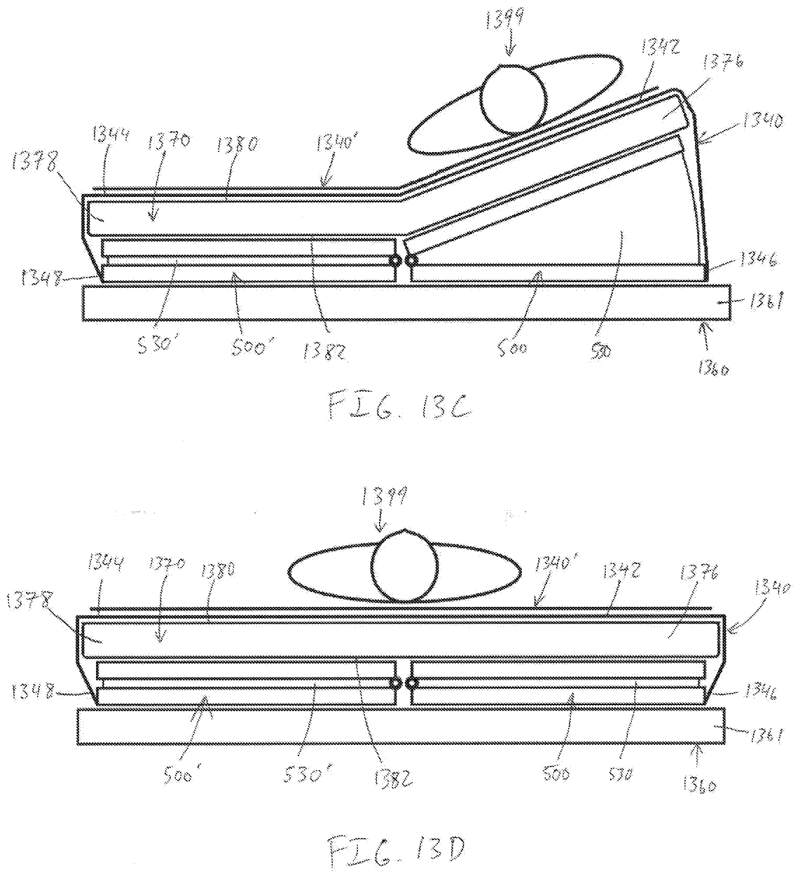

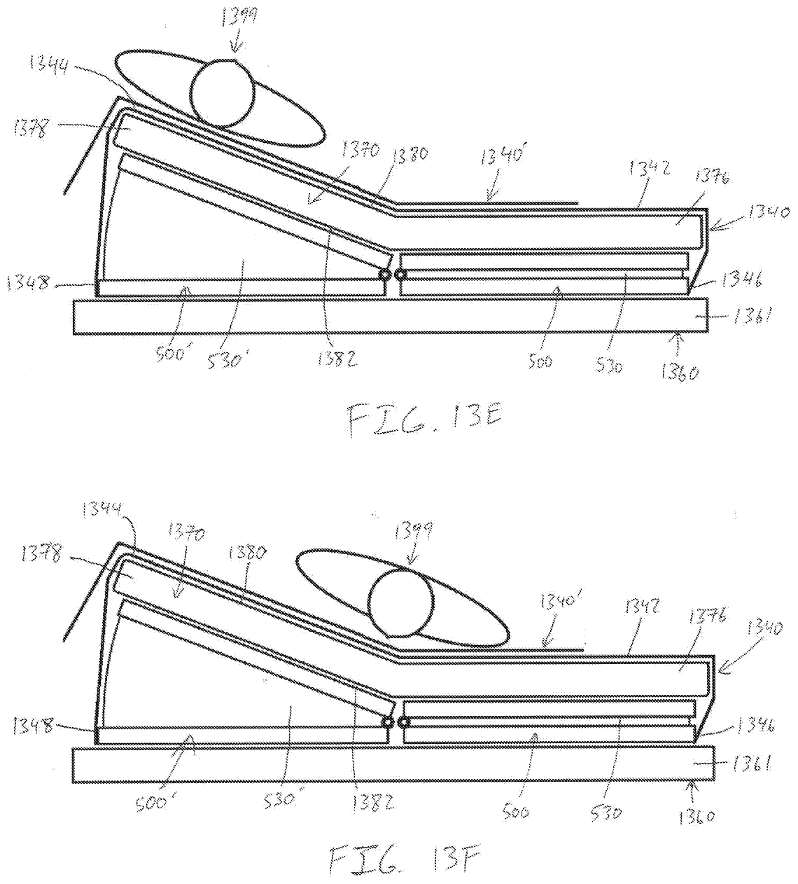

FIGS. 13A-13F show a method of turning a person 1399 in a range of 90-180 degrees on a support apparatus 1360, according to certain aspects. FIG. 13A shows a support apparatus 1360, for example, a mattress 1370 disposed on a hospital bed 1360. As with standard hospital beds 1360, the width of the mattress 1370 as measured from the first side 1376 to the second side 1378 is 36 inches. This limited width poses a problem for medical personnel when attempting to turn a person 1399 in a range of 90-180 degrees in a hospital bed 1360 because the average person laying in the center of the mattress 1370 does not have enough distance to either side of the person 1399 to roll 180 degrees before contacting the side rails of the hospital bed 1360. This problem is exacerbated when the person 1399 in the bed 1360 is obese because the person 1399 will have less distance to either side of the person 1399 and will move a longer distance when rolling in a range of 90-180 degrees.

In some implementations, the mattress is disposed on any type of bed or other structure. In some implementations, the mattress is disposed directly on the ground or a floor. In some implementations, the support apparatus is a wheelchair or any other device capable of supporting a person.

The mattress 1370 shown in FIGS. 13A-13F has a first side 1376, a second side 1378 opposite the first side 1376, a top surface 1380 extending between the first side 1376 and the second side 1378, and a bottom surface 1382 opposite the top surface 1380. Two of the devices 500, 500′ described above and shown in FIGS. 6A and 6B are disposed between the bottom surface 1382 of the mattress 1370 and the bed frame 1361. However, it will be appreciated by those skilled in the art that any of the devices disclosed herein can be used in this method as described below. A first device 500 is disposed adjacent the first side 1376 of the mattress 1370, and a second device 500′ is disposed adjacent the second side 1378 of the mattress 1370.

A first sheet 1340 is disposed along the top surface 1380 of the mattress 1370. The first sheet 1340 has a first side 1342 disposed adjacent the first side 1376 of the mattress 1370 and a second side 1344 disposed adjacent the second side 1378 of the mattress 1370. The first sheet 1340 further has a first edge 1346 along the first side 1342 of the first sheet 1340 and a second edge 1368 along the second side 1344 of the first sheet 1340. The first sheet 1340 is disposed on the top surface 1380 of the mattress 1370 such that the first edge 1346 of the first sheet 1340 is coupled to the first device 500 and the second edge 1368 of the first sheet 1340 is coupled to the second device 500′. The edges 1346, 1348 of the sheet 1340 can be coupled to the devices 500, 500′ by any of the means described above. A second sheet 1340′ is disposed along at least a portion of the first sheet 1340 such that the first sheet 1340 is disposed between the top surface 1380 of the mattress 1370 and the second sheet 1340′. A person 1399 is disposed on the second sheet 1340′.

To turn the person 1399 in the range of 90-180 degrees in the bed 1360, the first device 500 is activated to inflate the expandable volume 530, as shown in FIG. 13B and described above with respect to FIGS. 6A and 6B. As the expandable volume 530 of the first device 500 inflates, the first device 500 elevates the first side 1376 of the mattress 1370 and the first side 1342 of the first sheet 1340. Because the first sheet 1340 is coupled to the first device 500 and extends around the expandable volume 530, the inflation of the expandable volume 530 of the first device 500 causes the first sheet 1340 to shift, relative to the mattress 1370, in a direction toward the first side 1376 of the mattress 1370, in the same way as described above.

The first device 500 and the dimensions of the hospital bed mattress 1370 can shift the first sheet 1340 by 9 inches in the direction toward the first side 1376 of the mattress 1370. However, in some implementations, the first sheet is shifted 4 or more inches in the direction toward the first side of the mattress.

The shifting of the first sheet 1340 in the direction toward the first side 1376 of the mattress 1370 would typically cause the second sheet 1340′ disposed on top of the first sheet 1340 to tend to also shift toward the first side 1376 of the mattress 1370. However, as the person 1399 disposed on the second sheet 1340′ is shifted up the elevated and inclined first side 1342 of the first sheet 1340 on the first side 1376 of the mattress 1370, a caregiver can easily pull on an edge of the second sheet 1340′ to cause the second sheet 1340′ and the person 1399 to shift downhill due to gravity, as shown in FIG. 13C. Thus, the caregiver can easily cause the second sheet 1340′ to shift, relative to the mattress 1370 and the first sheet 1340, in a direction toward the second side 1378 of the mattress 1370.

Because the first device 500 has already shifted the first sheet 1340 in a direction toward the first side 1376 of the mattress 1370 by 9 inches, the caregiver can shift the second sheet 1340′ by 9 inches, relative to the first sheet 1340, to recenter the person 1399 on the mattress 1370. However, in implementations in which the first sheet is shifted 4 or more inches in the direction toward the first side of the mattress, the caregiver only needs to shift the second sheet 4 or more inches in the direction toward the second side of the mattress to recenter the person. In some implementations, the person is not recentered on the mattress after shifting the second sheet. In such implementations, the caregiver shifts the second sheet 4 or more inches in the direction toward the second side of the mattress to any position on the mattress.

It should be noted that each of the steps of shifting the first sheet 1340 in the direction toward the first side 1376 of the mattress 1370, elevating the first side 1342 of the first sheet 1340, and shifting the second sheet 1340′ in a direction toward the second side 1378 of the mattress 1370 can be performed sequentially or simultaneously with one or both of the other above-mentioned steps.

After the second sheet 1340′ has been shifted, the first device 500 can be deactivated to deflate the expandable volume 530 of the first device 500 and allow the first side 1376 of the mattress 1370 and first side 1342 of the first sheet 1340 to lower to the mattress's 1370 and the first sheet's 1340 original elevation, as shown in FIG. 13D. At this point in the method, the second sheet 1340′ and the person 1399 are located in their original position in the center of the mattress 1370. However, the first sheet 1340 has now shifted toward the first side 1376 of the mattress 1370 by 9 inches and remains in this position. Thus, the first sheet 1340 remains shifted 9 inches toward the first side 1376 of the mattress 1370 relative to the second sheet 1340′.

Once the first side 1376 of the mattress 1370 and the first sheet 1340 have been lowered, the second device 500′ is activated to inflate the expandable volume 530′, as shown in FIG. 13E and as described above with respect to FIGS. 6A and 6B. As the expandable volume 530′ of the second device 500′ increases, the second device 500′ elevates the second side 1378 of the mattress 1370 and the second side 1344 of the first sheet 1340. Because the first sheet 1340 is coupled to the second device 500′ and extends around the expandable volume 530′ of the second device 500′, the inflation of the expandable volume 530′ of the second device 500′ causes the first sheet 1340 to shift, relative to the mattress 1370, in a direction toward the second side 1378 of the mattress 1370, in the same way as described above. However, because the first sheet 1340 is already shifted 9 inches toward the first side 1376 of the mattress 1370, the second device 500′ causes the first sheet 1340 to shift 9 inches back to the center of the mattress 1370 and then an additional 9 inches toward the second side 1378 of the mattress 1370. Thus, the first sheet 1340 is able to shift a total of 18 inches in the direction toward the second side 1378 of the mattress 1370. Because the second sheet 1340′ and the person 1399 are disposed on top of the first sheet 1340, the second sheet 1340′ and the person 1399 also begin to move in the direction toward the second side 1378 of the mattress 1370.

As the person 1399 disposed on the second sheet 1340′ is shifted up the elevated and inclined second side 1344 of the first sheet 1340 on the second side 1378 of the mattress 1370, a caregiver can easily roll or turn the person 1399 in the direction toward the first side 1376 of the mattress 1370 downhill due to gravity as the second sheet 1340′ shifts in the direction toward the second side 1378 of the mattress 1370, as shown in FIG. 13F. This “treadmill” effect of the sheets 1340, 1340′ moving in one direction while the person 1399 is turned in the opposite direction allows the person 1399 to effectively “roll-in-place” relative to the mattress 1370. Because the person 1399 is moving relative to the first sheet 1340 and not the mattress 1370, the usable distance that the person 1399 can be turned or rolled is determined by the distance from the position of the person 1399 to the first 1346 of the first sheet 1340, which is increased by 18 total inches by the final shift of the first sheet 1340 in the direction toward the second side 1378 of the mattress 1370. This additional usable distance for turning the person 1399 allows a caregiver to turn the person 1399 in a range from 90 degree to a full 180 degrees in the bed 1360. In some implementations, the person may be turned less than 90 degrees or more than 180 degrees.

The second device 500′ and the dimensions of the hospital bed mattress 1370 shown in FIGS. 13A-13F can shift the first sheet 1340 by 9 additional inches in the direction toward the second side 1378 of the mattress 1370 (i.e., a total of 18 inches). However, in some implementations, the first sheet is shifted 4 or more additional inches in the direction toward the second side of the mattress. Because the first device has already shifted the first sheet in a direction toward the first side of the mattress by 9 inches, in implementations in which the first sheet is shifted 4 or more additional inches in the direction toward the second side of the mattress, the first sheet will only be shifted a total of 13 inches in the direction toward the second side of the mattress. Thus, the total distance to which the first sheet is shifted during this final shift in the direction of the second side is determined by the sum of the distances of both of the shifts of the first sheet. In some implementations, the methods described herein can be repeated to continue to turn the person further in the bed or to turn the person back to the person's initial position.

It should be noted that, although the steps of shifting the first sheet 1340 in the direction toward the second side 1378 of the mattress 1370, elevating the second side 1344 of the first sheet 1340, and rolling the person 1399 may be performed sequentially, the 18-inch total shift of the first sheet 1340 may cause the person 1399 to move all of the way to the second side 1378 of the mattress 1370 such that the person 1399 contacts the side rail of the bed 1360. In such situations, it may be necessary to begin the step of rolling the person 1399 in a range of 90-180 degrees in the direction toward the first side 1376 of the mattress 1370 simultaneously with the steps of shifting the first sheet 1340 in the direction toward the second side 1378 of the mattress 1370 and elevating the second side 1344 of the first sheet 1340.

Although the person 1399 shown in FIGS. 13A-13F begins in a supine position and is rolled 180 degrees to a prone position, it will be appreciated by those skilled in the art that the disclosed methods could be used to roll a person 180 degrees from a prone position to a supine position.

After the person 1399 has been rolled in a range of 90-180 degrees in the bed 1360, the second device 500′ can be deactivated to deflate the expandable volume 530′ of the second device 500′ and allow the second side 1378 of the mattress 1370 and second side 1344 of the first sheet 1340 to lower to the mattress's 1370 and the first sheet's 1340 original elevation.

Various other implementations include a method of replacing a sheet on a support apparatus while supporting a person. The support apparatus has a first side, a second side opposite the first side, a center portion located between the first side and the second side of the support apparatus, a top surface extending between the first side and the second side, and a bottom surface opposite the top surface. The support apparatus includes a first sheet disposed along at least a portion of the top surface. The first sheet has a first side and a second side. A person is disposed on the first sheet.

The support apparatus further includes a first expandable volume device and a second expandable volume device, such as the devices for moving a person on a support apparatus described above. The first expandable volume device is disposed adjacent the bottom surface and the first side of the support apparatus. The second expandable volume device is disposed adjacent the bottom surface and the second side of the support apparatus.

In some implementations, the first sheet is coupled to at least a portion of the support apparatus. In some implementations, the first sheet is coupled to a third expandable volume device located at the head of the support apparatus. Because, over time, the person tends to slide relative to the first sheet each time the third expandable volume is used to boost the person on the support apparatus, the first sheet moves toward the head of the bed relative to the person disposed on the first sheet. Thus, the third expandable volume device begins to lose its effectiveness with each use due to the slack in the first sheet. This method can be used along with the first expandable volume device and the second expandable volume device to replace or relocate the first sheet such that there is no longer slack in the sheet relative to the third expandable device. In implementations in which the first sheet is coupled to the third expandable device, the first sheet can initially be uncoupled from the third expandable device.

The first side of the support apparatus is then elevated by activating the first expandable volume device to cause the person to move in a direction toward the second side of the support apparatus. The person should then be lying only on the second side of the first sheet.

The first side of the sheet is then moved in a direction toward the second side of the support apparatus such that the first side of the sheet is gathered at the center portion of the support apparatus. As used herein, the term “gathered” is used to refer to bunching, rolling folding, or otherwise placing a particular portion or portions together into one or more locations. In some implementations, the first side of the sheet may be gathered between the person and the top surface of the mattress.

The first side of the support apparatus is then lowered, and the second side of the support apparatus is then elevated, to cause the person to move in a direction toward the first side of the support apparatus. In this position, the person has been moved past the gathered first side of the first sheet such that the person is no longer disposed on the first sheet. The first sheet can then be removed from the top surface of the support apparatus.

Next, a second sheet is disposed on the top surface of the support apparatus such that the second side of the second sheet is disposed adjacent the second side of the support apparatus and the first side of the second sheet is gathered at the center portion of the support apparatus. The second sheet is disposed closer to the foot of the support apparatus than the first sheet was when the first sheet was removed. This “resets” the location of the sheet such that there is no longer slack in the sheet relative to the third expandable volume device. In some implementations, the first side of the second sheet may be gathered between the person and the top surface of the mattress.

The second side of the support apparatus is then lowered, and the first side of the support apparatus is again elevated to cause the person to move back in a direction toward the second side of the support apparatus. In this position, the person has been moved past the gathered first side of the second sheet such that the person is disposed on the second side of the second sheet.

The first side of the second sheet can then be moved in a direction toward the first side of the support apparatus such that the first side of the second sheet is disposed adjacent the first side of the support apparatus. The second sheet can then be coupled to the third expandable volume device to boost the person in the support apparatus.

It should be noted that this same method can be used with a sheet that is configured as a sling, or any other feature that is disposed beneath a person on a support apparatus that must be replaced.

Various other implementations include a device for overlaying an inflatable cushion. The device includes a body having a first side and a second side opposite the first side. The device has a first axis extending along the second side and a second axis extending perpendicular to the first axis and along the second side. As shown, the device is disposed on a cushion such that the second side of the body contacts a surface of the cushion. Straps or web assemblies for a device for moving a person on a support apparatus, like those described above, can be extended over the body of the device such that the straps or web assemblies extend parallel to the second axis. The rigidity of the device along the second axis prevents the straps or web assemblies from digging into the cushion by spreading the pressure along the entire body of the device such that the device for moving a person on a support apparatus is effective throughout its entire actuation.

The straps or web assemblies can be spaced apart from each other by a distance in the range of 0.01 inches to 70 inches. In some implementations, the straps or web assemblies are spaced apart from each other by a distance in the range of 14 inches to 50 inches. The sheet or sling to be attached to the straps can be 1 inch long to 50 inches long. In some implementations, the straps are 20 inches long. Each of the straps can include from 1 to 10 loops for attachment. In some implementations, each strap includes 4 loops. Each strap can have a width in the range of 0.1 inches to 10 inches. In some implementations, each strap has a width of 1 inch. Each strap can be couplable to the body of the device by a loop and carabiner, but in some implementations, the strap is couplable to the body by a zipper, Velcro, a buckle, a ratcheting system, snap-on buttons, or any other suitable mechanism.

The body includes a first sheet and a second sheet partially coupled to each other to form a plurality of sleeves extending longitudinally parallel to the first axis. The body further includes a plurality of rigid rods. Each of the rods is disposed within a different one of the sleeves such that the rods extend parallel to each other and the first axis. The parallel rods cause the body to be rigid in a direction along the first axis and flexible in a direction along the second axis such that the body can be curved in a direction perpendicular to the first axis and the second axis. Thus, the device can flex around the curvature of the cushion but will stay rigid across the cushion when pressure is applied to the device.

The first sheet and second sheet of the body can be coupled in any way to form the sleeves, such as by sewing or welding.

The width of the body as measured along the first axis is dependent on the corresponding width of the inflatable cushion with which the device is designed to be used. In some implementations, the width of the body is in the range of 5 inches to 60 inches. In some implementations, the width of the body is in the range of 12 inches to 36 inches. In some implementations, the width of the body is 20 inches.

Depending on the size of the body, the device can include any number of sleeves and rods.

The rods shown in the figures are made of fiberglass rods, but in other implementations, the rods are made of metal (e.g., steel, aluminum, stainless steel, other alloys), a polymer (e.g., polypropylene, polyethylene, PVC, polyurethane, Delrin, fiber-reinforced plastics, and other commonly used plastics), natural materials (e.g., wood, bamboo), or composites (e.g., fiber-reinforced polymers, fiberglass, carbon fiber, Kevlar). The rods can be hollow or solid and can have any cross-sectional shape, such as circular, rectangular, triangular, hexagonal, octagonal, flat, ovate, or any other closed shape.

The length of the rods is dependent on the width of the body of the device, but in some implementations, the rods have a length in the range of 6 inches to 36 inches. In some implementations, the rods have a length of 20 inches. For rods having a length of 20 inches, the rods have a rigidity such that the rods only deflect 3 inches to 6 inches from end to end under normal loads. The rods can have a diameter in the range of 0.05 inches to 2 inches. In some implementations, the rods have a diameter in the range of 0.125 inches to 0.375 inches.

The sleeves, and thus the rods, can be equally spaced from each other or can variably space from each other such that they are closer to each other in areas of the body that receive the most load (e.g., the top of the cushion). In implementations in which the sleeves and rods are equally spaced from each other, the spacing of the rods can be in the range of 0.1 inches to 10 inches. In some implementations, the rods are spaced in the range of 0.5 inches to 1 inch.

When not in use, the body can be curved along the second axis and in the direction perpendicular to the first axis and the second axis into a roll having a diameter of 10 inches or less. In some implementations, the body can be rolled to have a diameter of 5 inches or less. In some implementations, the body can be rolled to have a diameter of 4 inches or less.

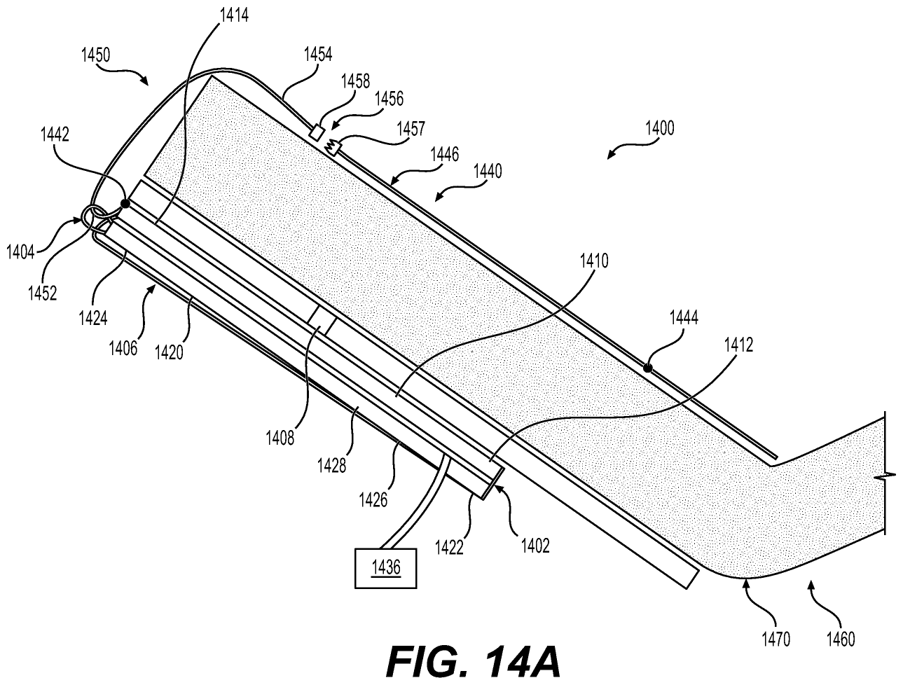

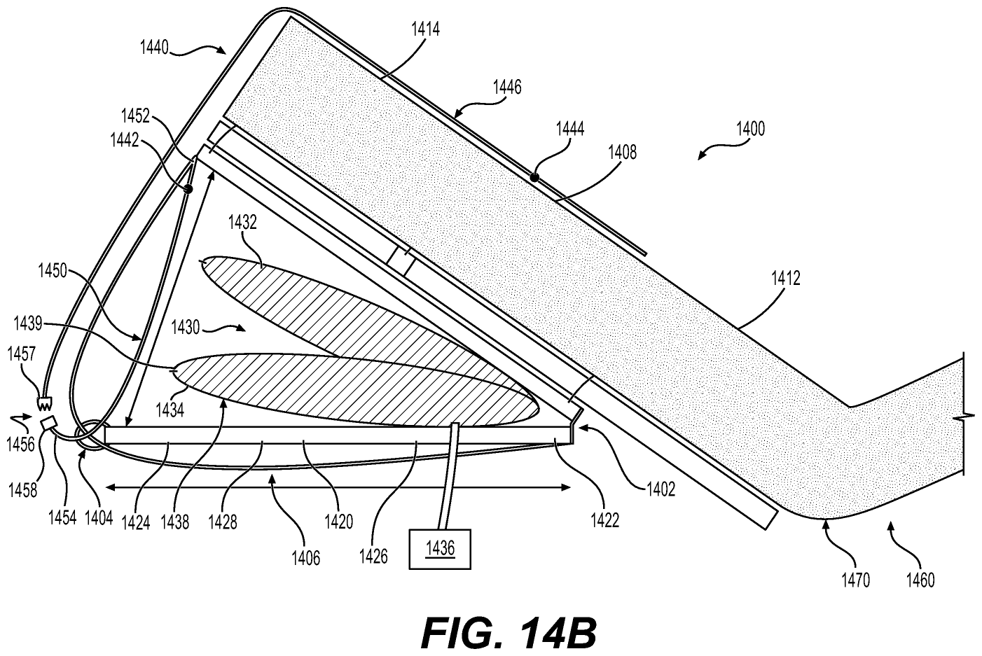

FIGS. 14A and 14B show another device 1400 for moving a person on a support apparatus 1460 according to other implementations. The device 1400 shown in FIGS. 14A and 14B is similar to the other implementations of devices disclosed herein, and it should be understood that one or more features of other devices disclosed herein can be used in combination with, or instead, of the features of the device 1400 shown in FIGS. 14A and 14B.

The device 1400 shown in FIGS. 14A and 14B includes a base 1402, an expandable volume 1430, a slider 1404, and a sheet 1440.

The base 1402 shown in FIGS. 14A and 14B is similar to the other bases disclosed herein. Thus, the base 1402 can be one or more rigid members or a flexible member. The base 1402 has a support apparatus coupler 1408 for coupling the device 1400 to a portion of a support apparatus 1460. The base 1402 shown in FIGS. 14A and 14B is shown coupled to the bottom side of the mattress 1470 of a bed, adjacent the head end of the mattress 1470. However, similar to other implementations disclosed herein, in some implementations, the support apparatus can be a chair, such as a wheel chair, or any other apparatus for supporting a patient. In some implementations, the support apparatus coupler is coupled adjacent the bottom side of a mattress of the bed. In some implementations, the support apparatus coupler is coupled to or adjacent any other portion of the support apparatus. In some implementations, the support apparatus coupler is couplable to or adjacent to a head end of a mattress of the bed. In some implementations, the support apparatus coupler is couplable to or adjacent to a side end of a mattress of the bed. In some implementations, the support apparatus coupler is couplable to or adjacent to a foot end of a mattress of the bed. In some implementations, the support apparatus coupler is couplable to or adjacent to a head end of a frame of the bed. In some implementations, the support apparatus coupler is couplable to or adjacent to a side end of a frame of the bed. In some implementations, the support apparatus coupler is couplable to or adjacent to a foot end of a frame of the bed.

The base 1402 includes a first base portion 1410 and a second base portion 1420. The first base portion 1410 shown in FIGS. 14A and 14B includes the support apparatus coupler 1408, but in some implementations, the second base portion can include the support apparatus coupler depending on the desired configuration of the device. In some implementations, the device only includes a single base portion or no base portion.

The first base portion 1410 and the second base portion 1420 are each rigid panels that are movable relative to each other as the expandable volume 1430 moves between the first position and the second position, as discussed herein. The first base portion 1410 has a first end 1412 and a second end 1414 opposite and spaced apart from the first end 1412, and second base portion 1420 has a first end 1422 and a second end 1424 opposite and spaced apart from the first end 1422 of the second base portion 1420.

The first base portion 1410 and the second base portion 1420 are both made of aluminum for its light weight and rigidity. However, in some implementations, the first base portion and the second base portion are made of any other material. Each of the first base portion 1410 and the second base portion 1420 include a honeycomb pattern of cavities in a middle layer that is laminated between two solid outer layers. The honeycomb pattern reduces the overall weight of the base portions 1410, 1420 while retaining much of the rigidity of a solid panel. However, in some implementations, the first base portion and the second base portion include any number of one or more internal cavities or one or more cavities that extend to a surface of the first base portion and/or the second base portion. In some implementations, the one or more cavities are in any configuration. In some implementations, the first base portion and the second base portion do not include cavities.

The base 1402 further includes a base cover 1426 defining two sleeves 1428. The first base portion 1410 and the second base portion 1420 are disposed within separate sleeves 1428 of the base cover 1426. The first end 1422 of the second base portion 1420 is pivotably coupled to the first end 1412 of the first base portion 1410 by the base cover 1426. However, in some implementations, the first base portion is pivotably coupled to the second base portion in any other way known in the art.

The expandable volume 1430 is disposed between the first base portion 1410 and the second base portion 1420. The expandable volume 1430 shown in FIGS. 14A and 14B is similar to the other expandable volumes disclosed herein. The expandable volume 1430 can be coupled to the first base portion 1410 and/or the second base portion 1420. The expandable volume 1430 has a first side 1432 and a second side 1434 opposite and spaced apart from the first side 1432.

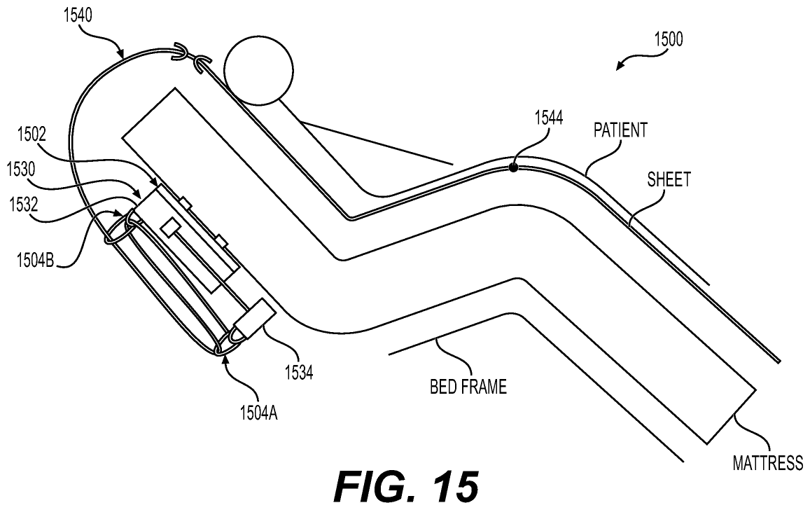

The expandable volume 1430 shown in FIGS. 14A and 14B includes two inflatable cushions, but in some implementations, such as the expandable volume 1530 shown in FIG. 15, the expandable volume 1530 can include a linear actuator. In some implementations, the expandable volume can include any of the other implementations of an expandable volume disclosed herein.

Similar to implementations of other devices disclosed herein, the expandable volume 1430 can further include a pumping device 1436 disposed externally to the inflatable cushions. The pumping device 1436 is in fluid communication with the inflatable cushions such that the pumping device 1436 can be actuated to cause the expandable volume 1430 to move between a first position to a second position, in which the inflatable cushions are collapsed in the first position and expanded in the second position.

Although the device 1400 shown in FIGS. 14A and 14B is configured such that actuation of the expandable volume 1430 from the first position to the second position does not raise a portion of the mattress 1470 of the bed, in some implementations, the device is disposable under the mattress such that actuation of the expandable volume from the first position to the second position raises a portion of the mattress of the bed, similar to various implementations disclosed herein.

The device 1400 further includes a volume cover 1438 in which the expandable volume 1430 is disposed. The volume cover 1438 is made of a flexible material including at least one sewn seam 1439. The sewn seam 1439 provides additional strength over a welded seam, like those that may be used for an inflatable cushion of the expandable volume 1430. The volume cover 1438 is configured to have a maximum volume, and the expandable volume 1430 is configured to have a maximum volume that is greater than the maximum volume of the volume cover 1438. Thus, when the expandable volume 1430 is disposed within the volume cover 1438, the volume of the expandable volume 1430 is restricted by the maximum volume of the volume cover 1438 and is prevented from expanding to the maximum volume of the expandable volume 1430. Because the expandable volume 1430 is prevented from reaching its maximum volume, the welded seams of the inflatable cushions of the expandable volume 1430 are not carrying the full load applied to the device 1400 and are not fully stressed. Instead, the relatively stronger sewn seams 1439 of the volume cover 1438 bare much of the load.

The sheet 1440 shown in FIGS. 14A and 14B includes a sheet body 1446 and one or more tethers 1450. The one or more tethers 1450 each have a first tether portion 1452 and a second tether portion 1454 longitudinally spaced apart from the first tether portion 1452. The second tether portions 1454 of each of the tethers 1450 is removably coupled to the sheet body 1446 by a side release buckle 1456, such as those known in the art. The side release buckle 1456 includes a male portion 1457 and a female portion 1458. The male portion 1457 is coupled to the sheet body 1446 and the female portion 1458 is coupled to the second tether portion 1454 of the one or more tethers 1450. However, in some implementations, the female portion is coupled to the sheet body and the male portion is coupled to the second tether portion of the one or more tethers. The second tether portion 1454 of the tethers 1450 shown in FIGS. 14A and 14B are longitudinally adjustable along the tether 1450 to change a distance from the sheet body 1446 to the first tether portion 1452, but in some implementations, the first tether portion of the tethers are longitudinally adjustable along the tether to change a distance from the sheet body to the first tether portion.

Although the sheet 1440 shown in FIGS. 14A and 14B includes side release buckles 1456, in some implementations, the sheet includes a strap and ladder lock buckle, any other type of buckle, a carabiner, or any other type of removable fastening device for removably coupling the second tether portion of the one or more tethers to the sheet body.

Although the second tether portion 1454 shown in FIGS. 14A and 14B is removably coupled to the sheet body 1446, in some implementations, the one or more tethers are permanently coupled to the sheet body. In some implementations, the sheet does not include any tethers.

The sheet 1440 includes a first portion 1442 and a second portion 1444 opposite and spaced apart from the first portion 1442. The first tether portion 1452 defines the first portion 1442 of the sheet 1440, and the sheet body 1446 defines the second portion 1444 of the sheet 1440. The second portion 1444 of the sheet 1440 is configured for supporting a patient on the support apparatus 1460. The first portion 1442 of the sheet 1440 (i.e., the first tether portions 1452 in FIGS. 14A and 14B) is stationary with respect to the base 1402.

The slider 1404 is disposed adjacent the second side 1434 of the expandable volume 1430. The slider 1404 is coupled to the second end 1424 of the second base portion 1420 such that the slider 1404 moves with the second base portion 1420 when the expandable volume 1430 is actuated from the first position to the second position. The slider 1404 shown in FIGS. 14A and 14B includes a D-ring or carabiner, but in some implementations, the slide includes a rigid or semi-rigid bar, a rope, a strap, or a chain.

The first portion 1442 of the sheet 1440 shown in FIGS. 14A and 14B, located at the first tether portion 1452, is coupled to the second end 1414 of the first base portion 1410. The one or more tethers 1450 of the sheet 1440 extend from the first base portion 1410, adjacent the first side 1432 of the expandable volume 1430, over the expandable volume 1430, and around a portion of the slider 1404 adjacent the second side 1434 of the expandable volume 1430. A portion of the sheet 1440 (i.e., either the sheet body 1446 or the one or more tethers 1450) extends from the slider 1404 adjacent the second side 1434 of the expandable volume 1430, over the expandable volume 1430, and back over the first side 1432 of the expandable volume 1430. The second portion 1444 of the sheet 1440 is disposed on a top surface of the mattress 1470 such that it can support the patient.

Actuation of the expandable volume 1430 from the first position to the second position causes the second base portion 1420 to pivot relative to the first base portion 1410. Because actuation of the expandable volume 1430 from the first position to the second position changes the distance between the second end 1414 of the first base portion 1410 and the second end 1424 of the second base portion 1420, the actuation increases a length of the one or more tethers 1450 extending from the second side 1434 of the expandable volume 1430 to the first side 1432 of the expandable volume 1430. This, in turn, causes the second portion 1444 of the sheet 1440 to be closer to the base 1402 in the second position than in the first position, which boosts a patient disposed on top of the second portion 1444 of the sheet 1440.

In implementations in which the sheet only includes a sheet body without tethers, the sheet would extend entirely from adjacent the first side of the expandable volume, over the expandable volume, around a portion of the slider adjacent the second side of the expandable volume, over the expandable volume, and over the first side of the expandable volume. In some implementations, the device further includes a strain gauge for measuring the strain exerted on the sheet during actuation of the expandable volume.

Compared to similar devices that only extend from the second side of the expandable volume, over the expandable volume, to the first side of the expandable volume, the device 1400 shown in FIGS. 14A and 14B is able to move the second portion 1444 of the sheet 1440 twice the distance toward the base 1402 along a path defined by the length of the sheet 1440 during actuation. This is because the sheet 1440 doubles back on itself when it extends around the slider 1404 and acts similarly to a pulley system.

In some implementations, such as the one shown in FIG. 15, the device 1500 includes a first slider 1504A adjacent the second side 1534 of the expandable volume 1530 and a second slider 1504B adjacent the first side 1532 of the expandable volume 1530. In this implementation, the sheet 1540 extends from adjacent second side 1534 of the expandable volume 1530, over the expandable volume 1530, and around a portion of the second slider 1504B adjacent the first side 1532 of the expandable volume 1530 prior to extending adjacent the first side 1532 of the expandable volume 1530, over the expandable volume 1530, around the portion of the first slider 1504A adjacent the second side 1534 of the expandable volume 1530, over the expandable volume 1530, and over the first side 1532 of the expandable volume 1530. Because the sheet 1540 of the device 1500 shown in FIG. 15 doubles back on itself two times, the device 1500 is able to move the second portion 1544 of the sheet 1540 three times the distance toward the base 1502 along a path defined by the length of the sheet 1540 during actuation compared to some devices disclosed herein.

In some implementations, the device includes a first slider adjacent the second side of the expandable volume, a second slider adjacent the first side of the expandable volume, and a third slider adjacent the second side of the expandable volume. In such implementations, the sheet extends from adjacent first side of the expandable volume, over the expandable volume, and around a portion of the third slider adjacent the second side of the expandable volume prior to extending adjacent the second side of the expandable volume, over the expandable volume, around the portion of the second slider adjacent the first side of the expandable volume and extending adjacent the first side of the expandable volume, over the expandable volume, around the portion of the first slider adjacent the second side of the expandable volume, over the expandable volume, and over the first side of the expandable volume. Because the sheet doubles back on itself three times, the device is able to move the second portion of the sheet four times the distance toward the base along a path defined by the length of the sheet during actuation compared to some devices disclosed herein. In some implementations, the device includes more than three sliders.

As shown in FIGS. 14A and 14B, the device 1400 further includes one or more elastic bands 1406. The elastic bands 1406 extend at least around a portion of the expandable volume 1430 from the first side 1432 to the second side 1434. The elastic bands 1406 resiliently create a spring force that biases the expandable volume 1430 toward the first position and allow the expandable volume 1430 to be urgable toward the second position. In use, the expandable volume 1430 can be actuated from the first position toward the second position, resiliently expanding the elastic bands 1406. Once the force actuating the expandable volume 1430 ceases, the elastic bands 1406 bias the expandable volume 1430 from the second position back toward the first position. This eliminates the need to actively move the expandable volume 1430 back to the first position. Although the device 1400 shown in FIGS. 14A and 14B includes elastic bands 1406 to create the spring force, in some implementations, the device uses any other resilient device to create a spring force to bias the expandable volume toward the first position and to urge the expandable volume toward the second position.

In some instances, such as in implementations in which the device is configured to be coupled to or adjacent the head end of a mattress, actuation of the expandable volume from the first position to the second position may cause the expandable volume to contact and apply force to the headboard of the frame of the bed. Over time, this force can cause failure in the headboard and/or other portions of the bed. In some cases, it may be appropriate to remove the headboard of the bed to avoid such failure.

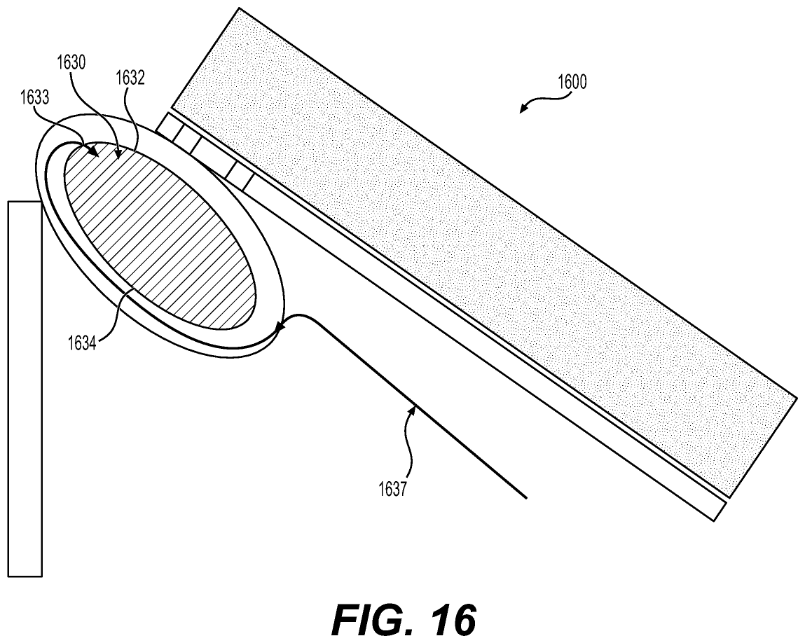

In some implementations, such as the device 1600 shown in FIG. 16, the device 1600 can include a flexible air supply tubing 1637 configured to supply air to the expandable volume 1630 and to prevent applying force to the headboard of the frame of the bed. The air supplied by the air supply tubing 1637 causes the expandable volume 1630 to actuate from the first position to the second position. The air supply tubing 1637 extends along the second side 1634 of the expandable volume 1630, and to an expandable volume inlet port 1633 disposed between the first side 1632 and second side 1634. The air supply tubing 1637 is in fluid communication with the inlet port 1633 of the expandable volume 1630 to actuate the expandable volume 1630. Because the air supply tubing 1637 extends along the portion of the expandable volume 1630 that would typically contact and apply force to the headboard, when the expandable volume 1630 contacts the headboard, the flexible air supply tubing 1637 is compressed between the expandable volume 1630 and the headboard. The compression of the flexible air supply tubing 1637 reduces the air flow through the tubing 1637, which prevents the expandable volume 1630 from actuating further toward the second position, which prevents the expandable volume 1630 from applying further force to the headboard.

Although the device 1600 shown in FIG. 16 includes only one air supply tubing 1637, in some implementations, the device can include two or more air supply tubings each extending from adjacent the base, along the second side of the expandable volume, and to the expandable volume inlet port disposed between the first side and second side of the expandable volume. In some implementations, the air supply tubing extends along any portion of the device that may contact and apply force to any object in an undesirable way such that the air supply tubing is compressed between the portion of the device and the object.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1.-87. (canceled)

88. A device for overlaying an inflatable cushion, the device comprising a body having a first side and a second side opposite the first side, the second side being configured to be disposed on a surface of the inflatable cushion, wherein the device has a first axis extending along the second side and a second axis extending perpendicular to the first axis and along the second side, wherein the body is rigid in a direction along the first axis, wherein the body is flexible in a direction along the second axis such that the body can be curved in a direction perpendicular to the first axis and the second axis.

89. The method of claim 88, further comprising an inflatable cushion, wherein the second side is disposed on a surface of the inflatable cushion.

90. The device of claim 88, wherein the device comprises a plurality of rigid rods, wherein each of the rods extends parallel to the first axis.

91. The device of claim 90, wherein the plurality of rods comprises fiberglass.

92. The device of claim 90, wherein the plurality of rods comprises metal.

93. The device of claim 90, wherein the plurality of rods comprises a polymer.

94. The device of claim 90, wherein the plurality of rods comprises a composite.

95. The device of claim 90, wherein one or more of the rods are hollow.

96. The device of claim 90, wherein the rods have a length in the range of 6 inches to 36 inches.

97. The device of claim 96, wherein the length of the rods is 20 inches.

98. The device of claim 90, wherein the rods have a diameter in the range of 0.125 inches to 0.375 inches.

99. The device of claim 90, wherein one or more of the rods has a circular cross section.

100. The device of claim 90, wherein each of the rods is spaced apart from an immediately adjacent rod by distance in the range of 0.5 inches to 1 inch.

101. The device of claim 90, wherein the plurality of rods includes at least three rods, wherein each of the rods is spaced apart from an immediately adjacent rod by an equal distance.

102. The device of claim 90, wherein the body further including a plurality of sleeves, wherein each of the rods is disposed within a different one of the sleeves.

103. The device of claim 102, wherein the body includes two sheets coupled together to form at least one of the sleeves.

104. The device of claim 89, wherein the inflatable cushion includes one or more web assemblies configured to be disposed on the first side of the body.

105. The device of claim 104, wherein the one or more web assemblies includes two web assemblies and the two web assemblies are spaced a distance from each other, wherein the distance is in the range of 14 inches to 50 inches.

106. The device of claim 88, wherein the body is curved in a direction perpendicular to the first axis and the second axis into a roll having a diameter of 10 inches or less.

107. The device of claim 88, further comprising an air supply tubing configured to supply air to the inflatable cushion to cause the inflatable cushion to move from the first position to the second position, wherein the air supply tubing extends along the second side of the body and to an inflatable cushion inlet port disposed between the first side and second side and with which the air supply tubing is in fluid communication.
